(19) United States
(12) Patent Application Publication
(10) Pub. No.: US 2026/0100305 A1
(43) Pub. Date: Apr. 9, 2026

(54) INSULATED COVERED CONDUCTIVE WIRE, COIL AND MAGNETIC COMPONENT

(71) Applicant: TDK CORPORATION, Tokyo (JP)

(72) Inventors: Ryoma NAKAZAWA, Tokyo (JP); Shinichi SASAKI, Tokyo (JP); Shohei ABC, Tokyo (JP)

(73) Assignee: TDK CORPORATION, Tokyo (JP)

(21) Appl. No.: 19/111,825

(22) PCT Filed: Nov. 29, 2023
(86) PCT No.: PCT/JP2023/042789

§ 371 Date: Mar. 14, 2025

(30) Foreign Application Priority Data
Nov. 30, 2022 (JP) 2022-192098
Nov. 30, 2022 (JP) 2022-192104

(51) Int. Cl. H01F 17/04; H01B 7/00; H01B 7/02; H01F 5/06

(52) U.S. Cl. CPC H01F 17/04; H01B 7/0009; H01B 7/02; H01F 5/06

(57) ABSTRACT

An insulated covered conductive wire which has a metal conductor part that contains Cu, and an insulating layer that covers the metal conductor part. The insulating layer in the insulated covered conductive wire contains Si, Ti and oxygen; and the ratio of the Ti content relative to the total content of Si and Ti in the insulating layer is 2.5 at % to 50 at %. Also disclosed is a coil that comprises a conductive wire which comprises a metal conductor part that contains Cu, and an insulating layer or inorganic insulating layer that covers the metal conductor part. The insulating layer in the coil contains an organic material which contains one or more inorganic elements M that are selected from among Si, Al, Zr, Zn, Ti, Nb, Ta, B, Ni and Mg. The inorganic insulating layer in the coil contains an oxide that contains an inorganic element M.

### TECHNICAL FIELD

The present disclosure relates to a conductive wire having an insulation coating, a coil, and a magnetic component including the coil.

### BACKGROUND

For electronic components such as inductors, transformers, choke coils, and so on, a conductive wire having an insulation coating is used as a material of a coil. In such electronic components, the insulation coating of the conductive wire has a function to ensure an insulation property between wound wires of the coil. As conventional electronic devices, a conductive wire with an insulation coating including a resin such as a polyamideimide resin, a polyimide resin, an epoxy resin, or a urethane resin is generally used. For example, Patent Document 1 discloses a conductive wire with an insulation coating which includes an epoxy resin, and Patent Document 2 discloses a conductive wire with an insulation coating which includes a copolymerized polyamide resin.

### PRIOR ART DOCUMENTS

### Patent Documents

[Patent Document 1] JP Patent No. 2890280
[Patent Document 2] JP Patent Application Laid Open No.H3-089414

### SUMMARY

The present disclosure provides an insulation coated conductive wire having a high heat resistance, a coil having a high heat resistance, and a magnetic component including the coil.

An insulation coated conductive wire according to the first aspect of the present disclosure includes:
a metal conductor part including Cu, and an insulation layer coating the metal conductor part;
wherein the insulation layer includes Si, Ti, and oxygen;
a ratio of a Ti content with respect to a total content of Si and Ti in the insulation layer is 2.5 at % or more and 50 at % or less.

An insulation coated conductive wire according to the second aspect of the present disclosure includes:
a metal conductor part including Cu, and an inorganic insulation layer coating the metal conductor part;
wherein the inorganic insulation layer includes an oxide including Si and Ti, and
a ratio of a Ti content with respect to a total content of Si and Ti in the inorganic insulation layer is 2.5 at % or more and 50 at % or less.

A coil according to the third aspect of the present disclosure includes:
a conductive wire including a metal conductor part including Cu, and an insulation layer coating the metal conductor part;
wherein the insulation layer includes an organic compound containing an inorganic element M which is one or more element selected from the group consisting of Si, Al, Zr, Zn, Ti, Nb, Ta, B, Ni, and Mg.

A coil according to the fourth aspect of the present disclosure includes:
a conductive wire including a metal conductor part including Cu, and an inorganic insulation layer coating the metal conductor part;
wherein the inorganic insulation layer includes an oxide containing an inorganic element M which is one or more element selected from the group consisting of Si, Al, Zr, Zn, Ti, Nb, Ta, B, Ni, and Mg.

A magnetic component according to the present disclosure includes:
the coil according to the third aspect or the fourth aspect, and a magnetic core including a soft magnetic material;
wherein the coil is embedded inside the magnetic core

### BRIEF DESCRIPTION OF DRAWINGS

FIG. 1 is a cross section of an insulation coated conductive wire according to an embodiment of the present disclosure.

FIG. 2 is a cross section of an insulation coated conductive wire having an inorganic insulation layer of after firing.

FIG. 3 is a perspective view showing one example of a coil using the insulation coated conductive wire shown in FIG. 1 and FIG. 2.

FIG. 4 is a cross section showing one example of an electronic component including the coil shown in FIG. 3.

FIG. 5A is a cross section showing a modified example of the insulation coated conductive wire.

FIG. 5B is a cross section showing another modified example of the insulation coated conductive wire.

FIG. 6 is a perspective view showing one example of the coil using the insulation coated conductive wire shown in FIG. 5A.

### DETAILED DESCRIPTION

In below, embodiments of the present disclosure are described by referring to figures. The embodiments of the present disclosure described in below are examples for explaining the present disclosure. Various configurational elements according to the embodiments of the present disclosure such as numerical values, shapes, materials, production steps, etc., can be modified or changed within a range which does not cause technical problems. Also, the shapes, etc., shown in the figures may not necessarily match the actual shapes, etc. This is because the shapes, etc., may be modified for explaining.

### First Embodiment

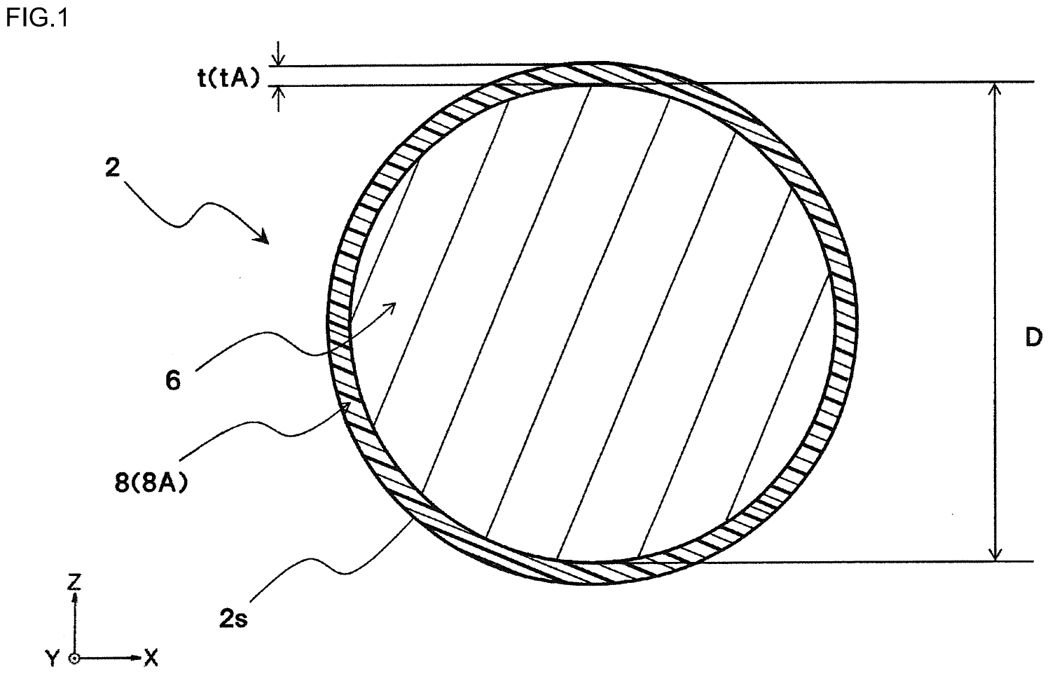

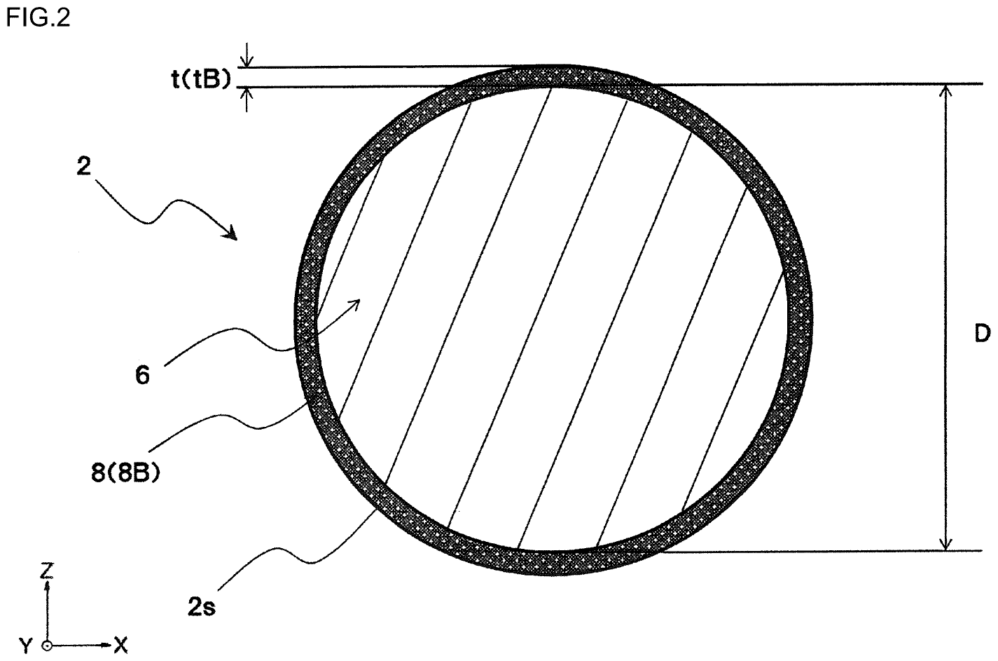

An insulation coated conductive wire 2 of the present embodiment is a wire material including a metal conductor part 6 and an insulation layer 8 coating the metal conductor part 6. A cross-sectional shape of the insulation coated conductive wire 2 is not particularly limited, and the insulation coated conductive wire 2 may have a cross-sectional shape of a circular shape, an oval shape, a rectangular shape, a square shape, or other polygon shapes. For example, for the insulation coated conductive wire 2 of a round wire shape as shown in FIG. 1 and FIG. 2, the metal conductor part 6 has a circular cross-sectional shape. Note that, FIG. 1 and FIG. 2 both show cross sections perpendicular to a longitudinal direction (Y-axis direction) of the insulation coated conductive wire 2, and X-axis, Y-axis, and Z-axis are perpendicular to each other in each figure.

An average diameter D of the metal conductor part 6 can be measured from the cross section shown in FIG. 1 and FIG. 2. In the case of the insulation coated conductive wire 2 is a round wire shape as shown in FIG. 1 and FIG. 2, for example, the average diameter D of the metal conductor part 6 is preferably 0.1 mm or larger and 1.5 mm or smaller. Note that, the range of this average diameter D is an example of a suitable size range when the insulation coated conductive wire 2 is used as a coil such as an inductor or so, and for any type of the use, the size of the metal conductor part 6 is not necessarily limited to the above-mentioned size range.

The metal conductor part 6 is a part where current flows, and it is a main functional part of the insulation coated conductor wire 2. Thus, the metal conductor part 6 is configured of a metal component, and it at least includes Cu. For example, the metal conductor part 6 may be pure copper, or copper alloy. The detailed composition of the metal conductor part 6 is not particularly limited, and preferably a main component which occupies at least 50 wt % of the metal conductor part 6 is Cu, and more preferably a content ratio of Cu in the metal conductor part 6 may be 70 wt % or more. In the case that metal conductor part 6 is configured of copper alloy, the metal conductor part 6 may include one or more element selected from the group consisting of Ag, Ni, Al, Zn, Be, Sn, Mn, etc., in addition to Cu. The composition of the metal conductor part 6 can be analyzed, for example, using an energy dispersive X-ray spectroscopy (EDS), or a wavelength dispersive X-ray spectroscopy (WDS).

The insulation layer 8 is a coating made of an insulation material which coats the metal conductor part 6. A coating ratio of the insulation layer 8 on the surface of the metal conductor part 6 is preferably 90% or more, and more preferably 100% or more. The coating ratio can be calculated by observing the cross section perpendicular to the longitudinal direction of the insulation coated conductive wire 2 as shown in FIG. 1 and FIG. 2. The insulation layer 8 is positioned at the outermost side of the insulation coated conductive wire 2, and the surface of the insulation layer 8 configures an outermost surface 2s of the insulation coated conductive wire 2.

An average thickness T_{Ave} of the insulation layer 8 is not particularly limited. In the case that the insulation coated conductive wire 2 is used for a coil such as an inductor, etc., the average thickness T_{Ave} of the insulation layer 8 is preferably 1 μm or thicker and 220 μm or thinner, and more preferably 1 μm or thicker and 200 μm or thinner. For the coil such as an inductor, etc., by setting the average thickness T_{Ave} within the above-mentioned range, increase in a leakage magnetic flux is suppressed while maintaining a high insulation resistance between the wound wires. Variations in the thickness of the insulation layer 8 is preferably within a range of ±10% of the average thickness T_{Ave}, and more preferably within a range of ±5% of the average thickness T_{Ave}. In other words, a tolerance of the thickness t of the insulation layer 8 is preferably within a range of ±10%, and more preferably within a range of ±5%.

In the case of calculating the average thickness T_{Ave} of the insulation layer 8, preferably at least 10 places from the cross section of the insulation coated conductive wire 2 are analyzed, and the thickness t of 10 places or more of the insulation layer 8 in each cross section are measured. Also, from this measurement, the maximum thickness t_{MAX} and the minimum thickness t_{MIN} of the insulation layer 8 are identified; and based on T_{Ave}, t_{MAX}, and t_{MIN}, the tolerance (%) of the thickness t of the insulation layer 8 may be calculated. Specifically, a deviation (t_{MAX}−T_{Ave}) of t_{MAX} with respect to T_{Ave} and a deviation (t_{MIN}−T_{Ave}) of t_{MIN} with respect to T_{Ave} are calculated, and the deviation exhibiting larger absolute value is divided by T_{Ave}, thereby the tolerance of the thickness is calculated. That is, “F1=(|t_{MAX}−T_{Ave}|/T_{Ave})×100” and “F2=(|t_{MIN}−T_{Ave}|/T_{Ave})×100” are calculated, and the larger value among F1 and F2 is used as the tolerance (%) of the thickness t.

The insulation layer 8 includes at least Si, Ti, and oxygen. Also, when a ratio of the Ti content with respect to a total content of Si and Ti in the insulation layer 8 (which is a ratio represented by Ti/(Ti+Si)) is 2.5 at % or more and 50 at % or less, more preferably 5.0 at % or more and 40 at % or less, and even more preferably 7.5 at % or more and 25 at % or less. By setting the ratio Ti/(Si+Ti) in the insulation layer 8 between 2.5 at % or more and 50 at % or less, variation in the thickness of the insulation layer 8 can be reduced, and a high heat resistance can be obtained.

The insulation layer 8 is preferably formed using a sol-gel method. In the case of forming the insulation layer 8 using a sol-gel method, specifications (dimension, material, etc.) of the metal conductor part 6 do not change between before firing and after firing; however, the condition of the insulation layer 8 changes. In the present embodiment, the insulation layer 8 prior to firing is referred to as “a pre-firing insulation layer 8A”, and the insulation layer 8 after firing is referred to as “an inorganic insulation layer 8B”. The pre-firing insulation layer 8A and the inorganic insulation layer 8B both satisfy 2.5 at %≤(Ti/(Si+Ti))≤50 at %; however, the pre-firing insulation layer 8A is a coating including an organic compound, and the inorganic insulation layer 8B is an oxide coating which substantially does not include an organic compound. In below, characteristics of the pre-firing insulation layer 8A and the inorganic insulation layer 8B are explained in detail together with a method of forming the insulation layer 8.

When forming the insulation layer 8 using a sol-gel method, first, a Si source in a liquid form and a Ti source in a liquid form are mixed to prepare a coating solution.

The Si source used for the coating solution is not particularly limited, and for example, preferably alkoxysilane is used. Examples of alkoxysilane include monoalkoxysilane, dialkoxysilane, trialkoxysilane, tetraalkoxysilane, etc. Examples of monoalkoxysilane include trimethylmethoxysilane, trimethylethoxysilane, trimethyl(phenoxy) silane, etc. Examples of dialkoxysilane include dimethyldimethoxysilane, dimethyldiethoxysilane, diisopropyldimethoxysilane, diisobutyldimethoxysilane, t-butylmethyldimethoxysilane, t-butylmethyldiethoxysilane, etc. Examples of trialkoxysilane include trimethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, etc. Examples of tetraalkoxysilane include tetramethoxysilane, tetraethoxysilane, tetrapropoxysilane, tetrasopropoxysilane, etc. As the Si source, one alkoxysilane may be used, or two or more alkoxysilane mentioned in above may be used together.

The Ti source used in the coating solution is not particularly limited, and for example, titanium alkoxide or titanium chelate is preferably used. Examples of titanium alkoxide include titanium tetramethoxide, titanium tetraethoxide, titanium tetra-n-propoxide, titanium tetraisopropoxide, titanium tetra-n-butoxide, etc. Examples of titanium chelate include titanium acetylacetonate, titanium tetraacetylacetonate, titanium ethylacetoacetate, titanium octyleneglycolate, ammonium salt of titanium lactate, titanium lactate, titanium triethanolamineate, etc. As the Ti source, one of titanium alkoxide or titanium chelate mentioned in above may be used, or two or more of titanium alkoxide or/and titanium chelate mentioned in above may be used.

The ratio Ti/(Si+Ti) of the insulation layer 8 may be controlled by a blending ratio of the Si source and the Ti source in the coating solution. Note that, in order to adjust a viscosity of the coating solution, an organic solvent may be added appropriately to the coating solution in addition to the Si source and the Ti source. In this case, the organic solvent being used is not particularly limited. For example, ethanol, n-propyl alcohol, isopropyl alcohol, acetone, or methylethyl ketone may be used as the organic solvent.

Next, using the above-mentioned coating solution, a pre-firing insulation layer 8A is formed using a dip coating method. Specifically, in a dip coating method, a wire material made only of the metal conductor part 6 is immersed in the above-mentioned coating solution, and then, the wire taken out of the coating solution is dried. As the wire material made only of the metal conductor part 6 which is prior to the immersion in the coating solution, a wire material produced using a known method may be prepared. Also, the step of immersing the wire material in the coating solution may be performed several times. A thickness tA of the pre-firing insulation layer 8A can be controlled by a length of immersion time in the coating solution, by a number of times of immersion in the coating solution, etc. For example, the immersion time per one immersion in the coating solution may be 1 second to 300 seconds, and a number of times of immersion in the coating solution may be 1 to 10 times.

Note that, in the case of performing the immersion step for a plurality of times, a drying treatment may be performed after each immersion, and conditions of the drying treatment are not particularly limited. For example, a drying temperature per one drying treatment may be 50° C. or higher and lower than 300° C., and a drying time per one drying treatment may be 0.5 hours to 3 hours.

Due to the above-mentioned dip coating method, the pre-firing insulation layer 8A is formed on the surface of the metal conductor part 6. Note that, a method of forming the pre-firing insulation layer 8A is not limited to a dip-coating method, and other methods such as a spray coating method or so may be used.

The pre-firing insulation layer 8A (FIG. 1) after the drying treatment is a coating of drying gel, which includes an organic compound such as a polymer compound, etc., derived from the Si source and the Ti source. A molecular structure of the organic compound included in the pre-firing insulation layer 8A is thought to change depending on the types of the Si source and the Ti source used for the coating solution, a degree of dryness, etc. A structural analysis of the organic compound included in the pre-firing insulation layer 8A may be difficult in some cases; thus, the molecular structure is not particularly limited, and the organic compound of the pre-firing insulation layer 8A at least includes Si and Ti. Other than these, the organic compound of the pre-firing insulation layer 8A includes C (carbon), H (hydrogen), and O (oxygen) which are general configurational elements of the organic compound.

Here, “the organic compound including Ti and Si” refer to an organic compound which includes a bond having Si and a bond having Ti in a molecular chain. Examples of the bond having Si include Si—O, Si—H, Si—OH, Si—OR (R is an organic functional group), etc. Similarly, examples of the bond having Ti includes Ti—O, Ti—H, Ti—OH, Ti—OR, etc. As mentioned in above, the structural analysis of the organic compound in the pre-firing insulation layer 8A is not necessarily easy; thus, the bond having Si and the bond having Ti are not particularly limited, and it is thought that at least Si—O and Ti—O are included in the organic compound of the pre-firing insulation layer 8A.

The pre-firing insulation layer 8A may include an oxide generated due to a partial decomposition of the organic compound. That is, the pre-firing insulation layer 8A may be a composite which includes the organic compound and an inorganic compound. Examples of the oxide generated due to a decomposition of the organic compound include SiO₂, TiO₂, Si—Ti—O (a composite oxide including Si and Ti), etc.

As mentioned in above, Si and Ti are thought to exist in the backbone of the polymer compound in the pre-firing insulation layer 8A. Some of Si and Ti may exist as oxides. The ratio Ti/(Si+Ti) of the pre-firing insulation layer 8A is 2.5 at % or more and 50 at % or less, more preferably 5.0 at % or more and 40 at % or less, and further preferably 7.5 at % or more and 25 at % or less.

The Si content (at %), the Ti content (at %), and the ratio Ti/(Si+Ti) of in the pre-firing insulation layer 8A, for example, can be calculated by a point analysis using EDS or WDS. The point analysis of EDS or WDS is preferably performed to at least 10 places, and the average thereof is calculated. When the total of elements detected by the point analysis is 100 at %, the total content of Si and Ti in the pre-firing insulation layer 8A is for example, preferably 1 at % or more and 10 at % or less, although it is not necessarily limited to this range.

The pre-firing insulation layer 8A includes C and H, and these elements are lost during a firing step which is described later. Among the elements included in the pre-firing insulation layer 8A, a content ratio RO of the elements which are lost due to firing is preferably 75 wt % or more and 90 wt % or less. The content ratio RO in the pre-firing insulation layer 8A may be calculated using Thermogravimetry-Differential Thermal Analysis (TG-DTA). Specifically, in the analysis using TG-DTA, a measurement sample taken from the insulation coated conductive wire 2 having the pre-firing insulation layer 8A is heated to 700° C. at a constant temperature increasing rate. Here, the content ratio RO of the elements which are lost due to firing may be calculated from a weight change of the measurement sample.

Note that, the pre-firing insulation layer 8A may include one or more element selected from the group consisting of B, Al, Zn, P, Ta, Nb, Bi, Ba, Ca, V, Ge, and Te. These elements may be added intentionally into the coating solution, or it may be included as impurities in the pre-firing insulation layer 8A.

An average thickness T1_{Ave} of the pre-firing insulation layer 8A is not necessarily limited, and preferably it is 1.5 μm or thicker and 220 μm or thinner. Variation of thickness tA of the pre-firing insulation layer 8A is preferably within a range of ±10% of the average thickness T1_{Ave}, and more preferably within a range of ±5% of the average thickness T1_{Ave}. In other words, a tolerance of the thickness tA of the pre-firing insulation layer 8A is preferably within a range of ±10%, and more preferably within a range of ±5%.

The insulation coated conductive wire 2 having the pre-firing insulation layer 8A is heat treated under predetermined heat treatment conditions (firing conditions) to sinter the pre-firing insulation layer 8A; thereby, the insulation coated conductive wire 2 having the inorganic insulation layer 8B shown in FIG. 2 can be obtained. The conditions of the heat treatment are not particularly limited, and for example, a holding temperature is preferably set to 300° C. or higher and 900° C. or lower (more preferably 500° C. or higher and 900° C. or lower), a temperature holding time is preferably 0.5 hours or longer and 10 hours or shorter. Also, the heat treatment may be performed under inert atmosphere such as nitrogen or so.

The organic compound including Si and Ti exists in the pre-firing insulation layer 8A, however, due to the above-mentioned heat treatment, the organic compound decomposes and oxidizes, and a coating including an oxide containing Si and Ti is formed. That is, Si and Ti in the organic compound remains in the inorganic insulation layer 8B, and becomes an oxide. On the other hand, most of the elements derived from the organic compound such as carbon, hydrogen, etc., included in the pre-firing insulation layer 8A vaporize and lost during oxidation or/and phase change of the pre-firing insulation layer 8A. For example, carbon in the pre-firing insulation layer 8A becomes CO₂ gas, and it is lost from the insulation layer. Also, hydrogen in the pre-firing insulation layer 8A becomes vapor (H₂O) and is lost from the insulation layer.

As mentioned in above, the inorganic insulation layer 8B after firing includes the oxide containing at least Si and Ti, and preferably does not substantially include the organic compound. The content (remaining amount) of the organic compound in the inorganic insulation layer 8B can be analyzed using TG-DTA. Specifically, in the analysis using TG-DTA, a measurement sample taken from the insulation coated conductive wire 2 having the inorganic insulation layer 8B is heated to 700° C. at a constant temperature increasing rate. Then, the weight of the organic compound can be calculated from the weight change of the measurement sample in the temperature range of 300° C. to 700° C. For example, using the sample weight at 300° C. as a standard, in the case that a change rate of the sample weight in the temperature range of 300° C. to 700° C. is within a range of ±3% (that is, within a range of −3% or more and +3% or less), it may be considered that the inorganic insulation layer 8B “does not substantially include the organic compound”.

The ratio Ti/(Si+Ti) in the insulation layer 8 barely changes before and after firing, hence the ratio Ti/(Si+Ti) in the inorganic insulation layer 8B is 2.5 at % or more and 50 at % or less, more preferably 5.0 at % or more and 40 at % or less, and further preferably 7.5 at % or more and 25 at % or less.

Also, the inorganic insulation layer 8B may include other elements in addition to Si, Ti, and oxygen. Examples of such other elements include B, Al, Zn, P, Ta, Nb, Bi, Ba, Ca, V, Ge, Te, etc. When a total content of elements excluding oxygen in the inorganic insulation layer 8B is 100 at %, a total content of Si and Ti in the inorganic insulation layer 8B is preferably 70 at % or more, and more preferably 80 at % or more.

The Si content (at %), the Ti content (at %), and the ratio Ti/(Si+Ti) in the inorganic insulation layer 8B can be calculated by a point analysis using EDS or WDS as similar to the analysis of the pre-firing insulation layer 8A. The point analysis of EDS or WDS is preferably performed to at least 10 places, and the average thereof is calculated.

Note that, the inorganic insulation layer 8B is preferably not in a state where granules or/and fibrous substances are deposited, and rather it is preferably a coating which is highly densified and uniform. For example, in the inorganic insulation layer 8B, Si and Ti are preferably distributed evenly without being locally concentrated, and the part where Si exists and the part where Ti exists preferably overlap. The distribution of Si and Ti in the inorganic insulation layer 8B, for example, can be confirmed by a mapping analysis using EDS or WDS. In a mapping image obtained after the analysis, concentrations of the measurement target elements (Si and Ti) are represented by brightnesses depending on integrated intensities of detected peaks (a characteristic X-ray peak detected at each measurement point); thus, it can be visually verified whether the measurement target elements are locally concentrated or not. Also, by using datum of brightnesses and integrated intensities obtained by the mapping analysis as a population, an average, a standard deviation, and a coefficient of variation (standard deviation/average), etc., of the population can be calculated; thereby, the distribution of the measurement target elements can be evaluated quantitatively. For example, in the inorganic insulation layer 8B, the coefficient of variation of Si distribution and the coefficient of variation of Ti distribution are both preferably 0.5 or less.

As mentioned in above, in the inorganic insulation layer 8B, the oxide including Si and Ti is a main phase, and preferably the main phases are homogeneously dispersed. For example, an area ratio of the main phases in the inorganic insulation layer 8B is preferably 80% or higher, or more preferably 90% or higher. In other words, in a cross section of the inorganic insulation layer 8B, a total area ratio of other phases besides the main phase is preferably 20% or lower, or more preferably 10% or lower. Such other phases refer to an oxide of which the composition is different from the oxide including Si and Ti, residual carbon, etc. Note that, each area ratio mentioned in the above may be calculated by analyzing the cross section of the inorganic insulation layer 8B using SEM, an optical microscope, etc., and the field of view during the cross-section analysis may be, for example, 100×100 μm² to 500×500 μm².

An average thickness T2_{Ave} of the inorganic insulation layer 8B is not necessarily limited, and it is preferably 1 μm or thicker and 200 μm or thinner. Also, a tolerance of the thickness tB of the pre-firing insulation layer 8A is preferably within a range of ±10%, and more preferably within a range of ±5%.

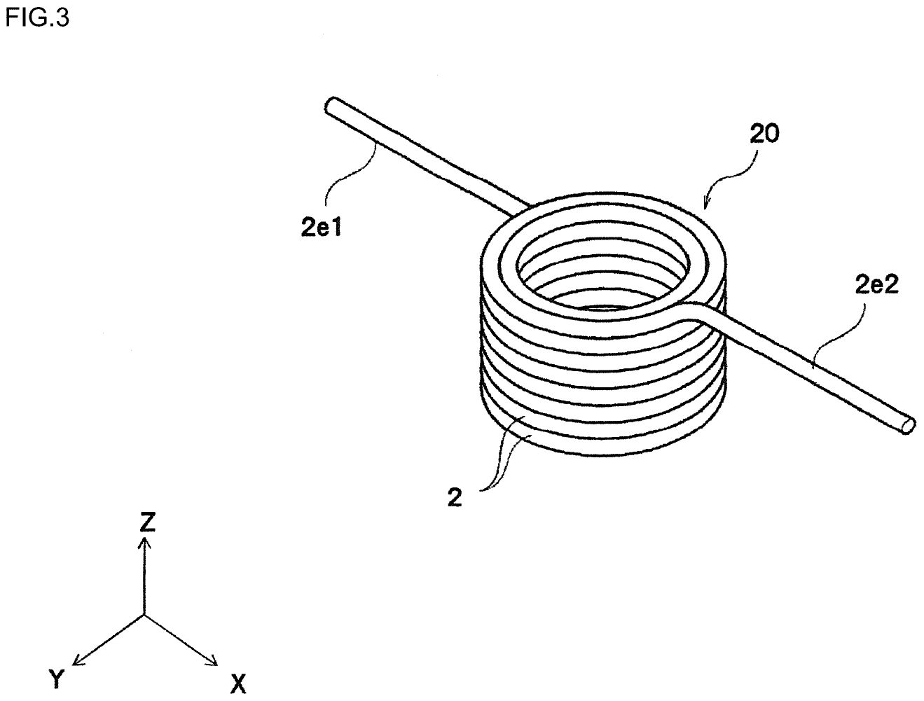

The use of the insulation coated conductive wire 2 is not particularly limited, and it can be particularly preferably used as a coil for an electronic component coil such as an inductor, a transformer, a choke coil, etc. For example, FIG. 3 is a perspective view which shows an example of a coil 20 made of the insulation coated conductive wire 2.

The coil 20 shown in FIG. 3 has a structure in which the insulation coated conductive wire 2 is wound in a spiral form along Z-axis. The coil 20 shown in FIG. 3 uses a multilayer regular wining as a winding method, however a winding method is not limited to this. For example, a winding method such as a single layer regular winding, an uneven winding, an oblique winding, a spaced winding, etc., may be used. The number of turns of the insulation coated conductive wire 2 of the coil 20 is not particularly limited, and it may be determined appropriately depending on the desired coil properties. For example, the number of turns of the insulation coated conductive wire 2 may be 0.5 turn to 100 turns. Also, in the case that the insulation coated conductive wire 2 is multilayer wound, the number of layers of wound wires is not particularly limited, and for example, it May 2 to 10 layers.

In the coil 20, end parts 2e1 and 2e2 of the insulation coated conductive wire 2 are each pulled out from a wound part towards outside in the X-axis direction. An external terminal, not shown in the figure, can connect to each of the end parts 2e1 and 2e2. The end parts 2e1 and 2e2 may have areas where the metal conductor part 6 are exposed by partially removing the insulation layer 8. Note that, shapes of the end parts 2e1 and 2e2 are not particularly limited, and the directions that the end parts 2e1 and 2e2 are pulled out are also not particularly limited.

When producing the coil 20, the insulation layer 8 may be formed first, and then the insulation coated conductive wire 2 may be wound around in a predetermined method. Alternatively, a wire material made only of the metal conductor part 6 may be wound in a coil form, and then the pre-firing insulation layer 8A may be formed on the surface of the metal conductor part 6 using a dip coating method, etc. In the case of forming the insulation layer 8 and then winding the insulation coated conductive wire 2, the insulation coated conductive wire 2 may be wound around before firing the insulation layer 8; or the insulation layer 8 may be fired, and then the insulation coated conductive wire 2 may be wound around. That is, the insulation coated conductive wire 2 having the pre-firing insulation layer 8A may be wound in a coil form, or the insulation coated conductive wire 2 having the inorganic insulation layer 8B, which is after firing, can be wound in a coil form.

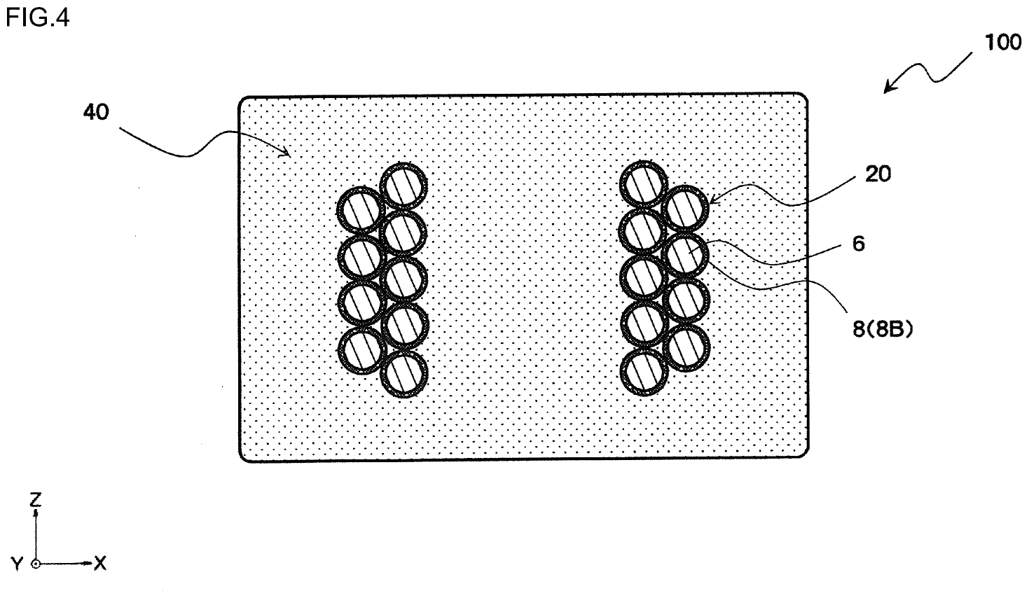

The coil 20 such as shown in FIG. 3 may be incorporated in a circuit as an air core coil, or it may be used by combining with a magnetic core. In the case of using for an electronic component having the magnetic core, the coil 20 is configured by winding the insulation coated conductive wire 2 around the bobbin made of a non-magnetic material, and then the bobbin and the magnetic core may be combined. Also, the magnetic core may be inserted in an inner circumference wall of the coil 20, or the coil 20 may be configured by winding the insulation coated conductive wire 2 to the outer surface of the magnetic core. Further, the coil 20 may be used by embedding inside a dust core including a magnetic powder and a resin. Particularly, since the insulation coated conductive wire 2 has a high heat resistance, the coil 20 can be embedded inside the magnetic core made of a sintered body. For example, FIG. 4 is a cross-section showing one example of the electronic component including the coil 20.

An electronic component 100 shown in FIG. 4 includes a magnetic core 40, the coil 20 existing inside the magnetic core 40, and an external terminal not shown in the figure. The magnetic core 40 is a sintered body of the magnetic powder, and it does not include a resin component such as an epoxy resin, a phenol resin, or a silicone resin. A shape and a dimension of the magnetic core 40 are not particularly limited. Also, the magnetic powder of the magnetic core 40 is not particularly limited, and for example, a soft magnetic metal powder is preferably used. Examples of the soft magnetic metal powder include, a Fe—Ni alloy powder, a Fe—Si alloy powder, a Fe—Si—Cr alloy powder, a Fe—Co alloy powder, a Fe—Si—Al alloy powder, a Fe-based amorphous alloy powder, a Fe-based nanocrystalline alloy powder, etc. A particle size of the magnetic powder is not particularly limited, and for example, an average particle size of the soft magnetic powder may be 1 μm or larger and 100 μm or smaller.

In the case that the magnetic powder is configured by the soft magnetic metal particles as mentioned in above, on the surface of each of the soft magnetic metal particles, a coating made by oxidizing the metal surface, an insulation coating such as a coating layer including an inorganic compound, or so may be formed. In this case, the adjacent soft magnetic metal particles are in contact with each other via the insulation coatings, or via a grain boundary phase including an Si-based oxide. In other words, an organic component such as a resin, etc., do not exist between the particles. An average thickness of the insulation coatings formed on the surfaces of the soft magnetic metal particles is not particularly limited, and it may be 5 nm or thicker and 200 nm or thinner.

Note that, the magnetic powder of the magnetic core 40 may be a mixed magnetic powder including two types or more of particle groups made of different particle compositions or/and particle sizes. For example, the Fe—Si alloy particle having the particle size of 25 μm or larger, and the pure Fe particle having the particle size smaller than 5 μm may be mixed and used as the magnetic powder.

In the electronic component 100, the coil 20 exists inside of the magnetic core 40 made of the sintered body, and the coil 20 is surrounded by and covered with the sintered magnetic powder. Note that, the sintered magnetic powder may exist not only around the coil 20 but also between the wound wires of the coil 20. As such, in the case that the coil 20 exists inside of the sintered body, the insulation layer 8 of the insulation coated conductive wire 2 exists as the sintered inorganic insulation layer 8B. That is, at the inside of the magnetic core 40, the inorganic insulation layer 8B insulates between the wound wires of the coil 20 (in which are between the metal conductor part 6 adjacent in the Z-axis direction).

Also, the end parts 2e1 and 2e2 of the insulation coated conductive wire 2 configuring the coil 20 are respectively pulled out to the outer surface of the magnetic core 40 from the inside of the magnetic core 40; and the end parts 2e1 and 2e2 are electrically connected with the external terminals provided on the outer surface of the magnetic core 40. At connecting portions between the end parts 2e1 and 2e2 and the external terminals, the inorganic insulation layer 8B is removed locally, and the metal conductor part 6 and the external terminals are in direct contact.

A method for producing the electronic component 100 is not particularly limited. For example, the magnetic core 40 may be produced using press molding. First, the coil 20 is placed in a cavity of a mold. Then, the cavity is filled with a composite material made by mixing the magnetic powder and the resin, and the inside of the cavity is pressurized by a predetermined pressure. Then, firing is performed to a molded body embedded in the coil 20; thereby, the magnetic core 40 is obtained as a sintered body including the coil 20. Conditions of firing are not particularly limited, and it may be set to conditions which can sinter the magnetic powder. For example, a firing temperature may be 500° C. or higher and 900° C. or lower, and a firing time may be 0.5 hour to 10 hours. Note that, prior to firing, a binder removal treatment may be performed.

Note that, during the production of the electronic component 100, the coil 20 having the inorganic insulation layer 8B may be embedded in the molded body. Alternatively, the coil 20 having the pre-firing insulation layer 8A may be embedded in the molded body, and firing of the pre-firing insulation layer 8A and firing of the magnetic core 40 may be carried out simultaneously. From the point of production efficiency, as mentioned in the latter case, preferably the insulation layer 8 is fired upon firing the magnetic core 40. In either case, at the inside of the magnetic core 40 after sintering, the inorganic insulation layer 8B of the coil 20 does not substantially include the organic compound.

Here, in general, the magnetic core made of a sintered body has a higher density than the dust core including the magnetic powder and the resin. Thus, in most cases, the magnetic core made of a sintered body has a higher permeability than the dust core including the magnetic powder and the resin.

However, in the case that the coil is made by using a conventional conductive wire having an insulation coating including a resin (for example, a polyamideimide resin, a polyimide resin, an epoxy resin, a urethane resin, etc.), the insulation coating on the coil surface may be burnt away by sintering the magnetic core as mentioned in above. Alternatively, the resin in the insulation coating formed on the coil surface is carbonized, and an electric resistance of the insulation coating may decrease significantly. As a result, the insulation property between the conductive wires of the coil may be compromised. That is, short circuits may occur between the conductive wires of the coil, and the number of turns of the wires of the coil may decrease. As a result, even if the magnetic core is sintered, inductance may decrease. On the contrary to this, in the case of using the coil 20 made of the insulation coated conductive wire 2, since the insulation layer 8 becomes the inorganic insulation layer 8B which has a high heat resistance during the firing step of the magnetic core 40, thus even after the magnetic core 40 is fired, the insulation property between the wires of the coil 20 can be maintained. That is, in the electronic component 100, “the magnetic core 40 made of a sintered body with a high permeability” and “the coil 20 which maintains the insulation property between the wires” are both achieved. Also, the magnetic powder existing around the coil 20 and existing between the wires can be suppressed from contacting the metal conductor part 6 of the conductive wire 2. As such, since the coil 20 has a high heat resistance, the magnetic core 40 can be sintered while the coil 20 is embedded, and by sintering the magnetic core 40, a filling rate of the magnetic powder in the magnetic core 40 can be improved. As a result, the electronic component 100 can attain a higher inductance than an electronic component made of the dust core including the magnetic powder and the resin.

### Summary of the First Embodiment

The insulation coated conductive wire 2 of the present embodiment includes the metal conductor part 6 including Cu and the insulation layer 8 coating the metal conductor part 6. The insulation layer 8 includes Si, Ti, and oxygen; and a ratio (Ti/(Si+Ti)) which is the Ti content with respect to the total content of Si and Ti in the insulation layer 8 is 2.5 at % or more and 50 at % or less.

The insulation layer 8 is formed using a sol-gel method, and Ti/(Si+Ti) barely changes before and after firing. That is, the insulation coated conductive wire 2 in the state after firing the insulation layer 8 includes the metal conductor part 6 including Cu and the inorganic insulation layer 8B coating the metal conductor part 6. The inorganic insulation layer 8B includes the oxide containing Si and Ti, and a ratio of Ti content (Ti/(Si+Ti)) which is with respect to the total content of Si and Ti in the inorganic insulation layer 8B is 2.5 at % or more and 50 at % or less.

When the insulation layer 8 (8A and 8B) satisfies 2.5 at %≤(Ti/(Si+Ti))≤50 at %, the uniformity of the insulation layer 8 can be improved. Also, when the insulation layer 8 (8A and 8B) satisfies 2.5 at %≤(Ti/(Si+Ti))≤50 at %, the insulation layer 8 having even higher insulation resistance can be obtained even after heat treated at a high temperature of 500° C. or higher. That is, when the insulation coated conductive wire 2 includes the insulation layer 8 (8A and 8B) which satisfies the predetermined Ti/(Si+Ti), a high heat resistance can be obtained.

Regarding the insulation coated conductive wire 2, the average thickness T_{Ave} of the insulation layer 8 is preferably 1 μm or thicker and 220 μm or thinner. Particularly, the average thickness T2 _{Ave} of the inorganic insulation layer 8B, which is a after firing is preferably 1 μm or thicker and 200 μm or thinner. By satisfying the above-mentioned average thicknesses, the heat resistance of the insulation coated conductive wire 2 is further enhanced. Also, in the case that the insulation coated conductive wire 2 is used for a coil such as an inductor or so, by satisfying the above-mentioned thicknesses, a space factor of the conductor (the metal conductor part 6) in the coil cross-section can be ensured sufficiently. As a result, decrease in inductance caused by the increase in leakage magnetic flux can be suppressed.

### Second Embodiment

In below, an embodiment of the present disclosure is described by referring to the figures. Sections which are not specifically mentioned are the same as the first embodiment.

As shown in FIG. 3, the coil 20 of the present embodiment contains a conductive wire 2 which is wound in a spiral form along the Z-axis. The conductive wire 2 may be the insulation coated conductive wire 2 of the first embodiment. Also, configurations of part of the conductive wire 2 may be the same as part of the insulation coated conductive wire 2 of the first embodiment.

The conductive wire 2 configuring the coil 20 of FIG. 3 is a round wire, and as shown in FIG. 1 and FIG. 2, the cross-section shape is a circular shape. Note that, the shape of the conductive wire 2 is not particularly limited to this, and the conductive wire 2 may be an oval shape, a rectangular shape, a square shape, or any other polygonal cross-section shape.

As shown in FIG. 1 and FIG. 2, the conductive wire 2 includes a metal conductor part 6 and an insulation coating (8A and 8B) which coats the metal conductor part 6. The insulation coating (8A and 8B) may be the insulation layer 8 of the first embodiment. Also, part of the configuration of the insulation coating (8A and 8B) may be the same as part of the configuration of the insulation layer 8 of the first embodiment.

The insulation coating (8A and 8B) includes an insulation material including a predetermined inorganic element M. Specifically, the inorganic element M is one or more element selected from the group consisting of Si, Al, Zr, Zn, Ti, Nb, Ta, B, Ni, and Mg. The number of types of the inorganic element M included in the insulation material is not particularly limited, and for example, it may one to three types. Also, from the point of extremely low decomposition property at room temperature after becoming oxides, and from the point of the high insulation property, the inorganic element M in the insulation material is preferably one or more element selected from the group consisting of Si, Al, Zr, Zn, Ti, Nb, Ta, and B.

The insulation coating (8A and 8B) of the conductive wire 2 is formed using a sol-gel method. In the case of forming the insulation coating using a sol-gel method, the specification (dimension, material, etc.) of the metal conductor part 6 does not change before and after firing; however, the state of the insulation coating changes. In the present embodiment, the insulation coating before firing is referred to as “a pre-firing insulation layer 8A” and the insulation coating after firing is referred to as “an inorganic insulation layer 8B”. In the pre-firing insulation layer 8A, the inorganic element M is contained in an organic compound, and the inorganic insulation layer 8B includes oxides configured of the inorganic element M. In below, one example of a method of forming the insulation coating is described in detail, and also characteristics of the pre-firing insulation layer 8A and the inorganic insulation 8B are described in detail.

When the insulation coating is formed using a sol-gel method, first, a coating solution is prepared using a raw material including the inorganic element M. As the raw material including the inorganic element M, a liquid organic compound which becomes an oxide after the firing treatment may be used. As such organic compound, for example, alkoxide, a chelate compound, etc., may be mentioned. In below, examples of the organic compound including the inorganic element M are described.

The Si source in the case of including Si as the inorganic element M is the same as the first embodiment.

The Ti source in the case of including Ti as the inorganic element M is the same as the first embodiment.

Examples of a Zr source, in the case of including Zr as the inorganic element M, include zirconium alkoxide such as zirconium tetramethoxide, zirconium tetraethoxide, zirconium tetra-n-propoxide, zirconium tetraisopropoxide, zirconium tetra-n-butoxide, etc. In the case of adding the Zr source in the coating solution, one type of zirconium alkoxide may be added, or two or more types of zirconium alkoxide may be used together.

Examples of an Al source, in the case of including Al as the inorganic element M, include aluminum alkoxide such as aluminum ethoxide, aluminum isopropoxide, aluminum secondary butoxide, etc; as well as aluminum chelate such as aluminum trisacetylacetonate, aluminum trisethyl acetoacetate, aluminum monoacetylacetonate bis(ethyl acetoacetate), etc. In the case of adding the Al source in the coating solution, one of aluminum alkoxide or aluminum chelate mentioned in above may be used, or two or more of aluminum alkoxide or/and aluminum chelate mentioned in above may be used together.

Following describes examples of including an element other than mentioned in above as the inorganic element M. As a Zn source, zinc alkoxide such as zinc ethoxide, etc., may be used. As a Nb source, niobium alkoxide such as pentaethoxy-niobium, etc., may be used. As Ta source, tantalum alkoxide such as pentalethoxy-tantalum, etc., may be used. As a B source, boron alkoxides such as tributyloxyborane, etc., may be used. As a Ni source, nickel alkoxide such as nickel diethoxide, etc., may be used. As a Mg source, magnesium alkoxide such as magnesium diethoxide, etc., may be used. In the case of adding the Zn source, the Nb source, the Ta source, the B source, the Ni source, or the Mg source mentioned in above in the coating solution, two or more of the alkoxides or/and the chelate compounds mentioned in above may be used together.

Note that, in order to adjust a viscosity of the coating solution, an organic solvent may be appropriately added to the coating solution in addition to the raw material including the inorganic element mentioned in above. The composition of the inorganic insulation layer 8B formed at the end and the content of the inorganic element M in the insulation layer (8A and 8B) may be controlled by adjusting a blending ratio of the raw material (the raw material including the inorganic element M) in the coating solution.

Next, using the above-mentioned coating solution, for example, the pre-firing insulation layer 8A is formed using a dip coating method. A wire material which is made only of the metal conductor part 6 of before dipping in the coating solution may be produced using a known method, or commercially available product may be purchased. The conductive wire made only of the metal conductor part 6 may be immersed in the coating solution in advance before processing into a coil shape. Alternatively, the wire material made only of the metal conductor part 6 may be wound into a coil form in advance, and then the wire material of a coil form may be immersed into the coating solution.

A thickness tA of the pre-firing insulation layer 8A and a thickness tB of the inorganic insulation payer 8B can be controlled by a length of time immersed in the coating solution, the number of immersions into the coating solution, etc.

The pre-firing insulation layer 8A of after a drying treatment (FIG. 1) is a coating of a dried gel which includes organic compounds such as a polymer compound derived from the organic compound of the raw material. A molecular structure of the organic compound included in the pre-firing insulation layer 8A is thought to change depending on the types of the raw material (organic compound) used for the coating solution, degree of dryness, etc. A structural analysis of the organic compound included in the pre-firing insulation layer 8A may be difficult in some cases, and the molecular structure is not particularly limited. The organic compound of the pre-firing insulation layer 8A may include at least the inorganic element M. As mentioned in above, the inorganic element M is one or more element selected from the group consisting of Si, Al, Zr, Zn, Ti, Nb, Ta, B, Ni, and Mg; and more preferably it is one or more selected from the group consisting of Si, Al, Zr, Zn, Ti, Nb, Ta, and B. Note that, in addition to the inorganic element M, the organic compound of the pre-firing insulation layer 8A includes C (carbon), H (hydrogen), and O (oxygen) which are general configurational elements of an organic compound.

Here, “the organic compound including the inorganic element M” refers to an organic compound which contains a bond including the inorganic element M in the molecular structure. That is, the inorganic element M exists in the molecular backbone of the organic compound; and examples of the bond including the inorganic element M include M-O, M-H, M-OH, M-OR (R is an organic functional group), etc. As mentioned in above, the structural analysis of the organic compound in the pre-firing insulation layer 8A is not easy, thus, although it is not particularly limited, the bond including the inorganic element M is thought to include the organic compound of the pre-firing insulation layer 8A which at least includes M-O.

The pre-firing insulation layer 8A may include an oxide which is formed due to a partial decomposition of the organic compound. The oxide formed due to decomposition of the organic compound is an oxide (M-Oₓ) which includes the inorganic element M. That is, the pre-firing insulation layer 8A may be a composite including the organic compound and the inorganic compound.

As mentioned in above, it is thought that, in the pre-firing insulation layer 8A, the inorganic element M exists in the backbone of the polymer compound, and the inorganic element M may exist as oxides. The inorganic element M included in the pre-firing insulation layer 8A can be identified by a point analysis using EDS or WDS. A point analysis using EDS or WDS is performed to at least 10 places in the cross-section of the pre-firing insulation layer 8A, and preferably the average thereof is calculated. When a total elements detected by the point analysis is 100 at %, the total content of the inorganic element M in the pre-firing insulation layer 8A is, for example, preferably 1 at % or more and 10 at % or less, although it is not limited to this range.

The average thickness T1_{Ave} of the pre-firing insulation layer 8A is not necessarily limited, and preferably it is 1.5 μm or thicker and 220 μm or thinner. A variation of the thickness tA of the pre-firing insulation layer 8A is within a range of ±10% of the average thickness T1_{Ave}, and more preferably +5% of the average thickness T1_{Ave}. In other words, a tolerance of the thickness tA of the pre-firing insulation layer 8A is preferably within a range of ±10%, and more preferably within a range of ±5%.

In the case of calculating the average thickness T1_{Ave} of the pre-firing insulation layer 8A, preferably at least 10 places from the cross section of the insulation coated conductive wire 2 are analyzed, and 10 places or more of the thickness tA of the pre-firing insulation layer 8A in each cross section are measured. Also, from this measurement, the maximum thickness t1_{MAX} and the minimum thickness t1_{MIN} of the pre-firing insulation layer 8A are identified, and based on T1_{Ave}, t1_{MAX}, and t1_{MIN}, the tolerance (%) of the thickness tA of the pre-firing insulation layer 8A may be calculated. Specifically, a deviation (t1_{MAX}−T1_{Ave}) of t1_{MAX} with respect to T1_{Ave} and a deviation (t1_{MIN}-T1_{Ave}) of t1_{MIN} with respect to T1_{Ave} are calculated, and the deviation exhibiting larger absolute value is divided by T1_{Ave}; thereby, a tolerance of the thickness tA is calculated. That is, “F1=(|t1_{MAX}−T1_{Ave}|/T1_{Ave})×100” and “F2=(|t1_{MIN}−T1_{Ave}|/T1_{Ave})×100” are calculated, and the larger value among F1 and F2 is used as the tolerance (%) of the thickness tA.

In the case that the pre-firing insulation layer 8A is formed before processing the conductive wire 2 into a coil form (before winding the conductive wire 2), the pre-firing insulation layer 8A may be sintered by performing heat treatment, and then the conductive wire 2 may be wound; or the conductive wire 2 may be wound, and then the pre-firing insulation layer 8A may be sintered by heat treating.

The organic compound including the inorganic element M exists in the pre-firing insulation layer 8A, however, due to the above-mentioned heat treatment, the organic compound decomposes and oxidizes. Thereby, a coating including an oxide containing the inorganic element M is formed. That is, the inorganic element M in the organic compound remains in the inorganic insulation layer 8B in a form of oxide.

As mentioned in above, the inorganic insulation layer 8B of after firing includes the oxide containing at least the inorganic element M, and preferably the organic compound is substantially not included.

The inorganic element M configuring the oxide of the inorganic insulation layer 8B is one or more element selected from the group consisting of Si, Al, Zr, Zn, Ti, Nb, Ta, B, Ni, and Mg as mentioned in above. More preferably, it is one or more element selected from the group consisting of Si, Al, Zr, Zn, Ti, Nb, Ta, and B as these have extremely low decomposition property at room temperature and can maintain a high insulation property. The inorganic insulation layer 8B may include carbides, nitrides, and inevitable impurities in addition to the above-mentioned oxide, and a content ratio of the oxide in the inorganic insulation layer 8B is preferably 50 mol % or more, and more preferably 75 mol % or more.

The oxide including the inorganic element M in the inorganic insulation layer 8B is expressed by “M-Oₓ” in a simplified style. When a total content of the elements excluding oxygen in the inorganic insulation layer 8B is 100 at %, a total content of the inorganic element M in the inorganic insulation layer 8B is 50 at % or more, and more preferably it is 75 at % or more.

Note that, in the inorganic insulation layer 8B, one or more element selected from the group consisting of P, Bi, Ba, Ca, V, Ge, and Te may be included. These elements may be added intentionally into the coating solution, or it may be included as impurities in the inorganic insulation layer 8B.

The oxide in the inorganic insulation layer 8B particularly preferably includes Si as the inorganic element M. When the oxides in the inorganic insulation layer 8B includes Si, one or two types of inorganic elements M may be further included in addition to Si. The inorganic element(s) M added together with Si is preferably one or more element selected from Ti, B, and Al. For example, the oxide in the inorganic insulation layer 8B is preferably Si—Ti—Oₓ, Si—B—Oₓ, or Si—B—Al—Oₓ.

When the oxide of the inorganic insulation layer 8B is Si—Ti—Oₓ, a ratio of the Ti content with respect to the total content of Si and Ti in the inorganic insulation layer 8B is preferably 2.5 at % or more and 50 at % or less, more preferably 5.0 at % or more and 40 at % or less, or even more preferably 7.5 at % or more and 25 at % or less. By making the ratio of the Ti content with respect to the total content of Si and Ti to 2.5 at % or more, the electric resistance of the inorganic insulation layer 8B can be further improved. Also, by making the ratio of the Ti content of the total content of Si and Ti to 50 at % or less, Ti can be efficiently incorporated in the Si—O backbone.

In the case that the oxide of the inorganic insulation layer 8B is Si—B—Oₓ, a ratio of the B content with respect to the total content of Si and B in the inorganic insulation layer 8B is preferably 1 at % or more and 20 at % or less, or more preferably 5 at % or more and 15 at % or less. By having the ratio of the B content with respect to the total content of Si and B within the above-mentioned range, when the conductive wire 2 is exposed under a high temperature environment of 300° C. or higher, there may be places on the insulation coating which are partially softened, thus it is possible to relieve heat stress generated between the metal conductor part 6 and the insulation coating.

In the case that the oxide of the inorganic insulation layer 8B is Si—B—Al—Oₓ, the ratio of the B content with respect to the total content of Si, B, and Al in the inorganic insulation layer 8B is preferably 1 at % or more and 20 at % or less, or more preferably 5 at % or more and 15 at % or less. Also, the ratio of the Al content with respect to the total content of Si, B, and Al in the inorganic insulation layer 8B is preferably 0.5 at % or more and 5 at % or less, or more preferably 1 at % or more and 3 at % or less. By having the B content or/and the Al content in Si—B—Al—Oₓ within the above-mentioned ranges, when the conductive wire 2 is exposed under a high temperature environment of 300° C. or higher, there may be places on the insulation coating which are partially softened, thus it is possible to relieve the heat stress generated between the metal conductor part 6 and the insulation coating.

The composition of the oxide and the content of the inorganic element M in the inorganic insulation layer 8B can be calculated by a point analysis using EDS or WDS. A point analysis using EDS or WDS is performed to at least 10 places in the cross-section of the inorganic insulation layer 8B, and preferably the average thereof is calculated. Note that, the composition of the oxide in the inorganic insulation layer 8B may be controlled based on a blending ratio of raw material (the organic compounds such as alkoxide, chelate compound, etc.) in the coating solution.

Note that, the inorganic insulation layer 8B is preferably not in a state where granules or/and fibrous substances are deposited, and rather it is preferably a coating which is highly densified and uniform. For example, in the inorganic insulation layer 8B, the element M is preferably evenly distributed without being locally concentrated. Also, in the case that the oxide in the inorganic insulation layer 8B includes two or more types of the inorganic elements M, the area where each inorganic element M exists preferably overlaps.

The distributions of the inorganic insulation layer M and oxygen in the inorganic insulation layer 8B can, for example, be confirmed by a mapping analysis using EDS or WDS. In a mapping image obtained by the analysis, concentrations of the measurement target elements (the inorganic element M and oxygen) are represented by brightnesses depending on integrated intensities of detected peaks (a characteristic X-ray peak detected at each measurement point); thus, it can be visually verified whether the measurement target elements are locally concentrated or not. Also, by using datum of brightnesses or integrated intensities obtained using the mapping analysis as a population, an average, a standard deviation, and a coefficient of variation (standard deviation/average) of the population can be calculated; thereby, the distribution of the measurement target elements can be evaluated quantitatively. For example, in the inorganic insulation layer 8B, the coefficient of variation regarding the distribution of each inorganic element M and the coefficient of variation of oxygen distribution are both preferably 0.5 or less.

As mentioned in above, in the inorganic insulation layer 8B, the oxide including the inorganic element M is a main phase, and such main phase is preferably dispersed evenly.

An average thickness T2 _{Ave} of the inorganic insulation layer 8B is not particularly limited, and it may be 1 μm or thicker and 200 μm or thinner. By setting the average thickness T2 _{Ave} of the inorganic insulation layer 8B to 1 μm or thicker, the insulation property of the coating can be further improved. Also, by setting the average thickness T2_{Ave} of the inorganic insulation layer 8B to 200 μm or thinner, a space factor of the metal conductor part 6 in the cross-section of the coil 20 can be secured sufficiently, and a decrease in the inductance, which occurs together with an increase in the leakage magnetic flux, can be suppressed.

Also, a variation of the thickness tB of the inorganic insulation layer 8B is preferably within a range of ±10% of the average thickness T2 _{Ave}, and more preferably within a range of ±5% of the average thickness T2_{Ave}. In other words, a tolerance of the thickness tB of the inorganic insulation layer 8B is preferably within a range of ±10%, and more preferably within a range of ±5%. The tolerance of the average thickness T2_{Ave} of the inorganic insulation layer 8B and the tolerance of the thickness tB of the inorganic insulation layer 8B may be calculated using the same method as in the case of the pre-firing insulation layer 8A.

The coil 20 of the present embodiment may be used by embedding inside the dust core including the magnetic powder and the resin. Note that, the coil 20 of the present embodiment has a high heat resistance, thus the coil 20 is particularly preferably used by embedding inside the magnetic core made of a sintered body. For example, FIG. 4 is a cross-section showing one example of a magnetic component including the coil 20.

The magnetic component 100 shown in FIG. 4 includes a magnetic core 40, the coil 20 existing inside the magnetic core 40, and external terminals not shown in the figure. A magnetic component 100 may be the electronic component 100 of the first embodiment. Also, part of the component of the magnetic component 100 may be the same as part of the configuration of the electronic component 100 of the first embodiment.

In the case of using the coil 20 of the present embodiment, the magnetic core 40 can be sintered while it is embedded inside the coil 20; and by sintering the magnetic core 40, the filling rate of the magnetic powder in the magnetic core 40 is improved. As a result, the permeability of the magnetic core 40 improves significantly, and thus the magnetic component 100 can achieve a higher inductance than a conventional magnetic component made of the dust core including the magnetic powder and the resin. Note that, the magnetic component 100 shown in FIG. 4 can be used as an inductor for various circuits.

### Summary of Second Embodiment

The coil 20 of the present embodiment includes the conductive wire 2 which is wound, and the conductive wire 2 includes the metal conductor part 6 including Cu and the insulation coating which coats the metal conductor part. The insulation coating existing on the surface of the coil 20 can be differentiated into the pre-firing insulation layer 8A and the inorganic insulation layer 8B depending on whether it is before or after firing.

The pre-firing insulation layer 8A which is an insulation coating of before firing includes the organic compound containing the inorganic element M which is one or more selected from the group consisting of Si, Al, Zr, Zn, Ti, Nb, Ta, B, Ni, and Mg. When the coil 20 having the pre-firing insulation layer 8A as mentioned in above is heated at a temperature of 300° C. or higher, the coating (the inorganic insulation layer 8B) of the oxide including the inorganic element M is formed on the surface of the metal conductor part 6. That is, the coil 20 having the pre-firing insulation layer 8A can maintain the insulation property between the wires not only before firing but also after firing. As a result, the coil 20 having the pre-firing insulation layer 8A can achieve a high inductance after firing.

The organic compound of the pre-firing insulation layer 8A preferably includes one or more selected from the group consisting of Si, Al, Zr, Zn, Ti, Nb, Ta, and B as the inorganic element M. When the coil 20 satisfies the above-mentioned conditions, the coating made of a stable oxide which hardly decomposes at room temperature can be obtained, and the insulation property between the wires can be maintained for a longer period of time.

The average thickness T1_{Ave} of the pre-firing insulation layer 8A is preferably 1.5 μm or thicker and 220 or thinner. When the pre-firing insulation layer 8A has the above-mentioned average thickness T1_{Ave}, the heat resistance of the coil 20 can be further improved.

The inorganic insulation layer 8B which is an insulation coating of after firing includes the oxide containing the inorganic element M which is one or more selected from the group consisting of Si, Al, Zr, Zn, Ti, Nb, Ta, B, Ni, and Mg. The inorganic insulation layer 8B such as mentioned in above has a high electric resistance, and short circuits between the wires can be prevented. That is, the coil 20 having the inorganic insulation layer 8B has a high heat resistance.

The oxide of the inorganic insulation layer 8B preferably includes at least one element selected from the group consisting of Si, Al, Zr, Zn, Ti, Nb, Ta, and B as the inorganic element M. When the coil 20 satisfies the above-mentioned conditions, the oxide in the coating becomes difficult to decompose at room temperature, and the insulation property between the wires can be maintained for a longer period of time.

The average thickness T2_{Ave} of the inorganic insulation layer 8B is preferably 1 μm or thicker and 200 μm or thinner. When the inorganic insulation layer 8B has the above-mentioned average thickness T2 _{Ave}, the heat resistance of the coil 20 can be improved even more. Also, th space factor of the metal conductor part 6 of the cross-section of the coil 20 can be secured sufficiently, and a decrease in the inductance, which occurs together with an increase in the leakage magnetic flux, can be suppressed.

As mentioned in above, since the coil 20 is highly heat resistant, when the coil 20 is used for the magnetic component, it is possible to sinter the magnetic core 40 containing the coil 20. For example, in the magnetic component 100 shown in FIG. 3, the coil 20 having the inorganic insulation layer 8B exists inside of the sintered magnetic core 40. In the magnetic component 100, the filling rate of the magnetic powder can be improved even more while maintaining the insulation property between the wires, compared to the dust core including the magnetic core and the resin. As a result, the permeability of the magnetic core 40 improves significantly, thus the magnetic component 100 can achieve a higher inductance than the conventional magnetic component.

Hereinabove, the embodiments of the present disclosure have been described; however, the present disclosure is not limited to the above-mentioned embodiments, and various modifications may be possible within the scope which does not exceed the gist of the present disclosure. Also, “insulation coated conductive wire” described in below may read “conductive wire”, and “insulation layer 8” may read “insulation coating (8A and 8B)”.

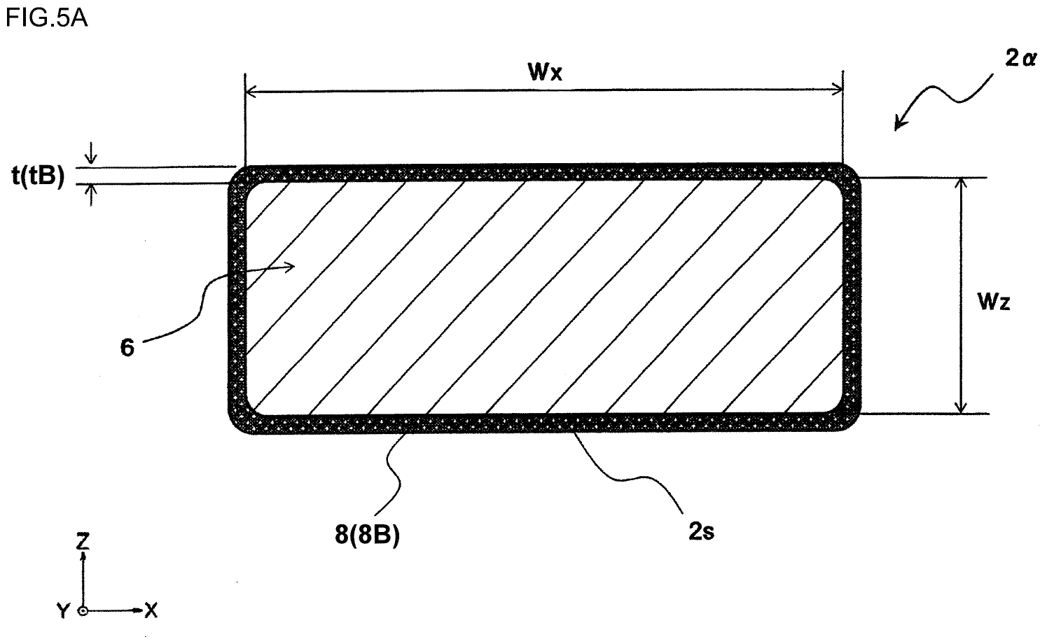

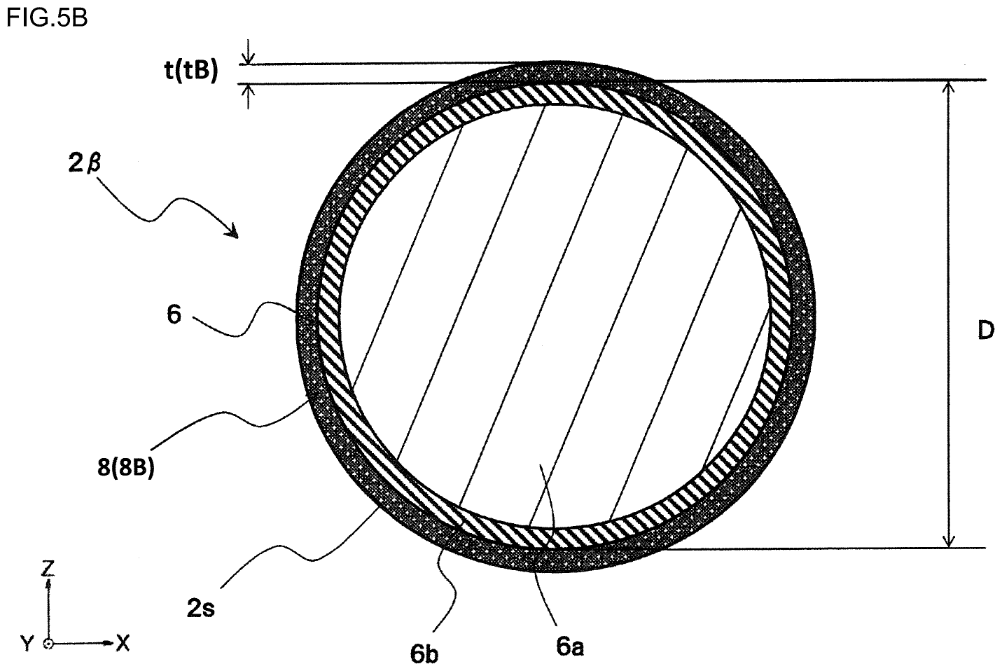

For example, as mentioned in above, the cross-section shape of the insulation coating conductive wire is not particularly limited, and the cross-section shape may be approximately a rectangular shape as in the case of an insulation coated conductive wire 2α having a rectangular wire shape as shown in FIG. 5A. In the case of the rectangular wire shape such as the insulation coated conductive wire 2α, a width Wx (longitudinal width) of the metal conductor part 6 in the X-axis direction is, for example, preferably 0.1 mm or thicker and 2.5 mm or thinner. A width Wz (short width) of the metal conductor part 6 in the Z-axis direction is, for example, 0.1 mm or thicker and 1.0 mm or thinner. The above-mentioned dimension is a suitable range when the insulation coated conductive wire 2α is used for a coil such as an inductor, etc., and the dimension of the metal conductor part 6 of the rectangular wire is not particularly limited regardless of the purpose of use.

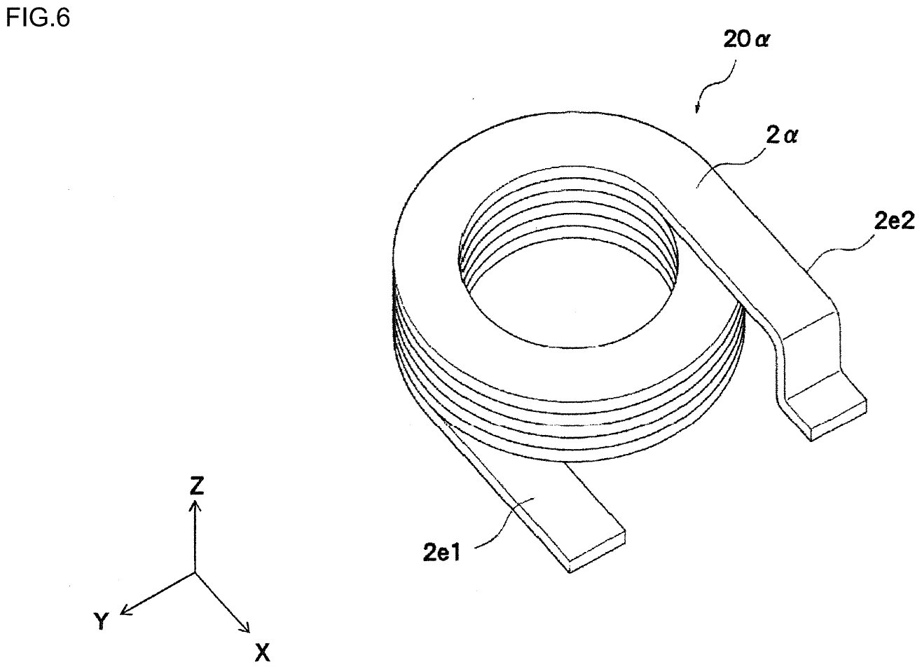

The coil 20α shown in FIG. 6 is one example of the insulation coated conductive wire 2α of a rectangular wire shape shown in FIG. 5A. As shown in FIG. 6, for the coil 20α, an edgewise winding is used, and the insulation coated conductive wire 2α is wound along the Z-axis so that the direction of the longitudinal width (Wx shown in FIG. 5A) crosses with the Z-axis (the coil axis). A method of winding in the case of using the insulation coated conductive wire 2α of a rectangular wire shape is not limited to that shown in FIG. 6, and a flatwise winding may be used as well. In the case of using a flatwise winding, the insulation coated conductive wire 2α is wound so that the direction of the longitudinal width (Wx shown in FIG. 5A) coincides with the Z-axis (the coil axis). In the case of using the insulation coated conductive wire 2α of a rectangular wire shape; the number of turns of the insulation coated conductive wire 2α is not particularly limited, and it may be determined appropriately depending on the desired coil properties.

Also, the metal conductor part 6 may include two or more areas with different compositions. For example, as shown in the insulation coated conductive wire 2β shown in FIG. 5B, the metal conductor part 6 may include a main part 6a and a metal coating layer 6b. In FIG. 5B, the insulation coated conductive wire 2β is a round wire having a circular cross-section shape, however, even in the case of the rectangular wire as shown in FIG. 5A, the metal conductor part 6 may have the main part 6a and the metal coating layer 6b. The metal coating layer 6b is a layer made of a metal component which coats the main part 6a, and it may be formed using a plating method, a vapor deposition method, etc. Also, the metal coating layer 6b may have a structure that two or more plating layers are stacked. Note that, in the case that the metal conductor part 6 has the metal coating layer 6b, the insulation layer 8 coats the surface of the metal coating layer 6b, and the insulation layer 8 is positioned at the outermost side of the insulation coated conductive wire 2β. By forming the metal coating layer 6b between the main part 6a of the metal conductor part 6 and the insulation layer 8, it is possible to improve the flexibility of the insulation coated conductive wire 2β.

In the case of that the insulation coated conductive wire 2ß shown in FIG. 5B, Cu may be included in either one of the main part 6a or the metal coating layer 6b, or Cu may be included in both of the main part 6a and the metal coating layer 6b. For example, the main part 6a may be pure copper or copper alloy (that is, the main component of the main part 6a is Cu), and the metal coating layer 6b including one or more element selected from the group consisting of Ni, Cr, Al, Ag, and Zn may be formed on the surface of the main part 6a. Alternatively, the main part 6a may be pure Al or Al alloy, and the metal coating layer 6b including Cu may be formed on the surface of the main part 6a (so-called copper clad aluminum wire).

An average thickness of the metal coating layer 6b is not particularly limited, and for example, it may be 10 μm or thicker and 150 μm or thinner. Also, the main part 6a may have an average diameter D of FIG. 1 or may have the same dimension as the widths Wx and Wz of FIG. 5A.

### EXAMPLES

In below, the present disclosure is described in further detail based on examples; however, the present disclosure is not limited thereto.

### (Experiment 1)

In Experiment 1, insulation coated conductive wires according to Samples A1 to A17 were produced following the steps shown in below. First, trimethoxysilane as a Si source and titanium tetra-n-butoxide as a Ti source were prepared, and a coating solution was prepared using these raw materials. Specifically, in each of Samples A2 to A16, a blending ratio of the Si source and the Ti source were controlled so that a ratio Ti/(Si+Ti) in an insulation layer satisfied a value shown in Table 1. Also, in a coating solution of Sample Al, the Si source was only added, and in a coating solution of Sample A17, the Ti source was only added.

Next, a Cu wire having an average diameter D of 500 μm was prepared, and the Cu wire was immersed in the above-mentioned coating solution for 30 seconds, and left still. Then, the Cu wire was taken out of the coating solution, and then it was dried. During a drying treatment, a holding temperature was set to 100° C. and a temperature holding time was set to 30 minutes. The immersion in the coating solution and the drying treatment were repeated for three times to obtain an insulation coated conductive wire having an insulation layer (pre-firing insulation layer). For each sample, below shown evaluations were performed to the insulation coated conductive wire of before firing.

### Measurement of Average Thickness and Thickness Tolerance of Insulation Layer

A cross-section of the insulation coated conductive wire was observed using a scanning electronic microscope (SEM), and a thickness tA of the pre-firing insulation layer existing on the surface of the Cu wire was measured. For each sample, 10 places of the cross-section of the insulation coated conductive wire were analyzed, and 10 places of the thicknesses tA of the pre-firing insulation layer of the cross section were measured. From the datum of the thicknesses tA obtained from the measurements, an average thickness T1_{Ave}, a maximum thickness t1_{MAX}, and a minimum thickness t1_{MIN} were calculated. Also, “F1=(|t1_{MAX}−T1_{Ave}|/T1_{Ave})×100” and “F2=(|t1_{MIN}−T1_{Ave}|/T1_{Ave})×100” were calculated, the larger value among F1 and F2 was used as a tolerance (%) of the thickness tA.

Regarding a uniformity of the thickness of the insulation layer, a sample which the thickness tolerance within a range of ±10% was considered good, and a sample which the thickness tolerance within a range of ±5% was considered particularly good.

### Component Analysis of Insulation Layer

During the cross-section analysis using SEM, a point analysis was carried out using EDS, and a Si content (at %) and a Ti content (at %) included in the pre-firing insulation layer were measured. Note that, the point analysis was carried out to at least 10 places, and an average of each of the Si content and the Ti content was calculated. Further, based on the measurement results, a ratio Ti/(Si+Ti) which is the Ti content with respect to a total content of Si and Ti in the pre-firing insulation layer was calculated.

### Measurement of Insulation Resistance of Insulation Layer

After coating was performed, an insulation resistance (Ω) of the insulation layer of before firing (pre-firing insulation layer) was measured using a high resistance meter 4339B made by HP. For this measurement, the pre-firing insulation layer was partially removed, that is, about ½ of the surface was removed. Further, one of measurement terminals was pressed against the area where the pre-firing insulation layer was removed (that is, the area where Cu as a metal conductor part was exposed). Further, the other measurement terminal was pressed against the surface of the pre-firing insulation layer; thereby, the insulation resistance was measured. For the insulation resistance of the pre-firing insulation layer, 1×10⁷Ω or higher was considered “pass”. Note that, “ND” shown in the section of the insulation resistance of Table 1 means that the insulation resistance was less than 1×10³Ω, and it also means that the insulation resistance was unable to measure.

### <Firing of Insulation Layer>

The samples (Samples A5 to A17) which were able to measure the insulation resistance during the evaluation of before the above-mentioned firing, in order to sinter the insulation layer, a heat treatment (firing treatment) was carried out to the insulation coated conductive wire. For the heat treatment, a holding temperature was set to 700° C. and a temperature holding time was set to 1 hour. Due to this heat treatment, the insulation layer was sintered, and the insulation coated conductive wire having the inorganic insulation layer was obtained.

Regarding the insulation coated conductive wire of after firing of each sample, an average thickness and a thickness tolerance of the inorganic insulation layer, a component analysis of the inorganic insulation layer, and the measurement of the insulation resistance of the inorganic insulation layer were performed by the same method performed before firing. Also, exterior of the inorganic insulation layer formed after firing was observed to verify whether cracks were formed on the inorganic insulation layer.

### Evaluation of Heat Resistance

A heat resistance of the insulation coated conductive wire was evaluated based on the insulation resistance (Ω) of the inorganic insulation layer of after firing, and also based on the result of exterior observation of the inorganic insulation layer. Specifically, in the case that no cracks were observed and the insulation resistance was 1×10⁶Ω or higher, it was evaluated as “good heat resistance”; and in the case that no cracks were observed and the insulation resistance was 1×10¹⁰Ω or higher, then it was evaluated as “particularly good heat resistance”.

Evaluation results of Experiment 1 are shown in Table 1.

TABLE 1

| | | | | | | Insulation layer (inorganic insulation | | | | |
|---|---|---|---|---|---|---|---|---|---|---|
| | | Insulation layer before firing | | | | layer) after firing | | | | |
| | Example/ | Ti/(Si + | Average | Thickness | Insulation | Ti/(Si + | Average | Thickness | Insulation | |
| Sample | Comparative | Ti) | thickness | tolerance | resistance | Ti) | thickness | tolerance | resistance | |
| No | example | at % | μm | % | Ω | at % | μm | % | Ω | Cracks |
| A1 | Comparative | 0.0 | — | — | ND | — | — | — | — | — |
| | example | | | | | | | | | |
| A2 | Comparative | 0.2 | — | — | ND | — | — | — | — | — |
| | example | | | | | | | | | |
| A3 | Comparative | 1.1 | — | — | ND | — | — | — | — | — |
| | example | | | | | | | | | |
| A4 | Comparative | 2.4 | — | — | ND | — | — | — | — | — |
| | example | | | | | | | | | |
| A5 | Example | 3.7 | 30 | ±4.8 | 3.40 × 10¹³ | 3.7 | 21 | ±3.4 | 1.40 × 10¹³ | None |
| A6 | Example | 5.2 | 30 | ±3.5 | 9.90 × 10¹⁴ | 5.2 | 22.3 | ±2.6 | 7.45 × 10¹³ | None |
| A7 | Example | 7.5 | 30 | ±3.1 | 1.40 × 10¹⁵ | 7.5 | 23.7 | ±2.4 | 1.20 × 10¹⁵ | None |
| A8 | Example | 12.5 | 30 | ±3.4 | 2.10 × 10¹⁵ | 12.5 | 25.1 | ±2.8 | 1.81 × 10¹⁵ | None |
| A9 | Example | 25.0 | 30 | ±3.9 | 4.00 × 10¹⁵ | 25.0 | 25.6 | ±3.3 | 2.91 × 10¹⁵ | None |
| A10 | Example | 40.0 | 30 | ±4.1 | 8.90 × 10¹⁴ | 40.0 | 26.1 | ±3.6 | 4.90 × 10¹⁴ | None |
| A11 | Example | 49.5 | 30 | ±4.5 | 1.40 × 10¹⁴ | 49.5 | 26.3 | ±3.9 | 1.25 × 10¹⁴ | None |
| A12 | Comparative | 53.0 | 30 | ±12.3 | 1.21 × 10¹⁴ | 53.0 | 26.5 | ±10.3 | 1.08 × 10¹⁴ | Found |
| | example | | | | | | | | | |
| A13 | Comparative | 75.0 | 30 | ±11.1 | 2.65 × 10¹⁴ | 75.0 | 27.7 | ±10.7 | 1.35 × 10¹⁴ | Found |
| | example | | | | | | | | | |
| A14 | Comparative | 82.0 | 30 | ±10.9 | 1.05 × 10¹⁴ | 82.0 | 27.8 | ±10.1 | 7.05 × 10¹³ | Found |
| | example | | | | | | | | | |
| A15 | Comparative | 90.0 | 30 | ±15.3 | 2.10 × 10¹⁴ | 90.0 | 27.9 | ±13.1 | 1.10 × 10¹⁴ | Found |
| | example | | | | | | | | | |
| A16 | Comparative | 95.0 | 30 | ±16.1 | 1.10 × 10¹⁴ | 95.0 | 28.3 | ±14.1 | 1.03 × 10¹⁴ | Found |
| | example | | | | | | | | | |
| A17 | Comparative | 100.0 | 30 | ±13.9 | 2.74 × 10¹⁴ | 100.0 | 28.7 | ±12.9 | 1.34 × 10¹⁴ | Found |
| | example | | | | | | | | | |

In regards with Samples A1 to A4, which are comparative examples, it was confirmed that oxidized particles were deposited on the surface of Cu which was the metal conductor part, and a continuous coating was not formed. Therefore, regarding Samples A1 to A4, a thickness of the coating layer was not measured. For Samples A1 to A4, there was no significant difference between a resistance value which was measured on the surface of the deposits and a resistance value of the metal conductor part (Cu wire). Hence, a coating having a sufficient resistance value was not formed.

Also, in regards with Samples A12 to A17, which are comparative examples, a tolerance of the thickness of the insulation layer was too large, and a uniformity was not secured. Therefore, for Samples A12 to A17, a heat stress generated during firing became uneven, and cracks were partially formed on the inorganic insulation layer. That is, sufficient heat resistance was not achieved for the insulation coated conductive wires of Samples A12 to A17.

On the other hand, regarding Samples A5 to A11, which are examples, for both of before and after firing, a tolerance of the thickness was within a range of ±5% of the average thickness, hence it was confirmed that an insulation layer having a high uniformity was formed. Also, regarding Samples A5 to A11, a high insulation resistance was maintained and also cracks were suppressed from forming even after heat treating at 700° C. Based on this result, it was confirmed that a high heat resistance can be attained when the insulation coated conductive wire had an insulation layer satisfying 2.5 at %≤Ti/(Si+Ti)≤50 at %.

### (Experiment 2)

In Experiment 2, insulation coated conductive wires of 10 different types having different average thicknesses of pre-firing insulation layers were produced. In Samples B1 to B9 of Experiment 2, the same coating solution used in Sample A6 of Experiment 1 was used, and a ratio Ti/(Si+Ti) was adjusted to 5.2 at %. Also, an average thickness of the pre-firing insulation layer of each sample was adjusted to the value shown in Table 2 based on the repeating number of the coating steps. Production conditions of Experiment 2, other than mentioned in above, were the same as Experiment 1, and for each sample of Experiment 2, the same evaluations as in the case of Experiment 1 were carried out. Results are shown in Table 2.

TABLE 2

| | | | | | | Insulation layer (inorganic insulation | | | | |
|---|---|---|---|---|---|---|---|---|---|---|
| | | Insulation layer before firing | | | | layer) after firing | | | | |
| | Example/ | Ti/(Si + | Average | Thickness | Insulation | Ti/(Si + | Average | Thickness | Insulation | |
| Sample | Comparative | Ti) | thickness | tolerance | resistance | Ti) | thickness | tolerance | resistance | |
| No | example | at % | μm | % | Ω | at % | μm | % | Ω | Cracks |
| B1 | Example | 5.2 | 0.5 | ±3.1 | 1.40 × 10⁷ | 5.2 | 0.3 | ±3.0 | 5.32 × 10⁶ | None |
| B2 | Example | 5.2 | 1.6 | ±3.5 | 1.25 × 10¹³ | 5.2 | 1.1 | ±2.8 | 8.25 × 10¹² | None |
| B3 | Example | 5.2 | 10 | ±3.2 | 3.30 × 10¹⁴ | 5.2 | 7.3 | ±2.5 | 2.15 × 10¹³ | None |
| B4 | Example | 5.2 | 20 | ±3.8 | 6.60 × 10¹⁴ | 5.2 | 15 | ±2.5 | 3.24 × 10¹³ | None |
| A6 | Example | 5.2 | 30 | ±3.5 | 9.90 × 10¹⁴ | 5.2 | 22 | ±2.6 | 7.45 × 10¹³ | None |
| B5 | Example | 5.2 | 50 | ±3.1 | 1.65 × 10¹⁵ | 5.2 | 35 | ±2.7 | 5.65 × 10¹⁴ | None |
| B6 | Example | 5.2 | 100 | ±3.3 | 3.30 × 10¹⁵ | 5.2 | 94 | ±2.8 | 7.31 × 10¹⁴ | None |
| B7 | Example | 5.2 | 150 | ±4.8 | 4.95 × 10¹⁵ | 5.2 | 135 | ±4.2 | 9.95 × 10¹⁴ | None |
| B8 | Example | 5.2 | 219 | ±4.9 | 6.60 × 10¹⁵ | 5.2 | 199 | ±4.6 | 1.60 × 10¹⁵ | None |
| B9 | Example | 5.2 | 221 | ±9.7 | 7.26 × 10¹⁵ | 5.2 | 201 | ±9.2 | 3.26 × 10¹⁵ | None |

According to the results shown in Table 2, when the average thickness of the pre-firing insulation layer was set to 1 μm or thicker and 220 μm thinner (in other words, when the average thickness of the inorganic insulation layer was set to 1 μm or thicker and 200 μm thinner), it was confirmed that the uniform inorganic insulation layer having a high insulation property can be obtained.

### (Experiment 3)

In Experiment 3, air core coils of 15 types as shown in Table 3 and Table 4 (Examples 1 to 13 shown in Table 3 and Comparative examples 1 and 2 shown in Table 4) were produced by following the steps shown in below.

### Examples 1 to 13

First, as a conductive wire, a Cu wire of rectangular wire shape having a cross-section dimension of 0.65 mm×0.180 mm was prepared, and a pre-firing insulation layer was formed on the surface of the Cu wire using a dip coating method.

Upon forming the pre-firing insulation layer, first, a coating solution added with raw materials containing an inorganic element M was prepared. Specifically, for each example, a coating solution including the below shown raw materials was prepared. Example 1 used trimethylethoxysilane (Si source). Example 2 used aluminum secondary-butoxide (Al source). Example 3 used zirconium tetra-n-propoxide (Zr source). Example 4 used zinc ethoxide (Zn source). Example 5 used titanium tetra-n-butoxide (Ti source). Example 6 used pentaethoxy niobium (Nb source). Example 7 used pentaethoxy tantalum (Ta source). Example 8 used tributoxy borate (B source). Example 12 used nickel diethoxide (Ni source). Example 13 used magnesium diethoxide (Mg source). Also, Example 9 used a coating solution in which trimethylethoxy silane and titanium tetra-n-butoxide were blended. Example 10 used a coating solution in which trimethylethoxy silane and tributoxy borate were blended. Example 11 used a coating solution in which trimethylethoxy silane, tributoxy borate, and aluminum secondary-butoxide were blended.

Next, the Cu wire of a rectangular wire shape was immersed in the above-mentioned coating solution for 30 seconds, and left still. Then, the coil was taken out from the coating solution, and heated to dry at 100° C. for 30 minutes. The immersion in the coating solution and the drying treatment were repeated for three times, and thereby, the Cu wire having the pre-firing insulation layer was produced.

Next, the Cu wire having the pre-firing insulation layer was wound in a spiral form using an edgewise method, and thereby, an air core coil having the pre-firing insulation layer was obtained. Here, the number of turns of the Cu wire was set to 6.5 turns, and an inner diameter after winding was set to 2.0 mm.

### Analysis of Insulation Coating Before Firing

A cross-section of the conductive wire configuring the air core coil was observed using a scanning electron microscope (SEM), and a thickness tA of the pre-firing insulation layer existing on the surface of the Cu wire was measured. Ten places of the cross-section of the conductive wire were analyzed per each sample, and the thickness tA of 10 places were measured in each cross-section. Then, from the measured results, an average thickness T1_{Ave} (μm) was calculated. Also, for each example, during the cross-section analysis using SEM, a point analysis using EDS was performed, and an inorganic element M included in the organic compound of the pre-firing insulation layer was identified. In each example, it was confirmed that the inorganic element M shown in Table 3 was included as intended according to the components of the coating solution.

### Measurement of Inductance L1 Before Firing

An inductance L1 (μH) of the air core coil before firing was measured using a LCR meter. Here, a measuring frequency was set to 1 MHz.

### <Firing of Insulation Coating>

In order to sinter the pre-firing insulation layer, a heat treatment (firing treatment) was performed to the air core coil of each example. For the heat treatment, a holding temperature was set to 700° C. and a temperature holding time was set to 1 hour. For each example, due to the heat treatment, the pre-firing insulation layer was sintered, and the air core coil having the inorganic insulation layer was obtained.

### Analysis of Insulation Coating After Firing

An average thickness T2_{Ave} of the inorganic insulation layer of each example was measured using the same method used to analyze the pre-firing insulation layer before firing. Also, during the cross-section analysis using SEM, a point analysis using EDS was performed, and an inorganic element M included in an oxide of the inorganic insulation layer was identified. In each example, as similar to the pre-firing insulation layer, it was confirmed that the inorganic element M shown in Table 3 was included in the oxide as intended according to the components of the coating solution.

An amount of the organic compound remaining in the inorganic insulation layer was measured using TG-DTA, and it was confirmed that, in all of the examples, the inorganic insulation layer substantially did not include the organic compound. Also, a mapping analysis was carried out using EDS, and it was confirmed that, in each example, the inorganic compound and oxygen were evenly distributed while overlapping on each other in the inorganic insulation layer. It was also confirmed that an area ratio of the oxide including the inorganic element M was 90% or larger with respect to an area of the inorganic insulation layer.

Note that, in Example 9, the inorganic insulation layer included an oxide represented by Si—Ti—Oₓ, and a ratio of a Ti content with respect to a total content of Si and Ti in the inorganic insulation layer was within a range of 2.5 at % or more and 50 at % or less. In Example 10, the inorganic insulation layer included an oxide represented by Si—B—Oₓ, and a ratio of a B content with respect to a total content of Si and B in the inorganic insulation layer was within a range of 1 at % or more and 20 at % or less. Also, in Example 11, the inorganic insulation layer included an oxide represented by Si—B—Al—Oₓ, and a ratio of a B content with respect to the total content of Si, B, and Al in the inorganic insulation layer was within a range of 1 at % or more and 20 at % or less, and a ratio of an Al content was within a range of 0.5 at % or more and 5 at % or less.

### Measurement of Inductance L2 After Firing

As similar to the case before firing, an inductance L2 (μH) of the air core coil after firing was measured using a LCR meter. Here, a measuring frequency was set to 1 MHz.

### Heat Resistance Evaluation of Coil

A heat resistance of the coil was evaluated based on a change rate (%) of the inductance after firing. Specifically, the inductance change rate was calculated by placing the inductance L1 of before firing and the inductance L2 of after firing into a formula “((L2−L1)/L1×100”. In Experiment 3, when a sample had an inductance change rate of −25% or larger, the heat resistance of the sample was considered “good”; and when a sample had an inductance change rate of −15% or larger, the heat resistance of the sample was considered “particularly good”.

### Comparative Example 1 and Comparative Example 2

For Comparative example 1, a Cu wire of a rectangular wire shape having an insulation coating made of a polyamideimide resin was prepared, and the Cu wire was wound in a spiral form using an edgewise method. Thereby, an air core coil was produced. A dimension of a conductor part in a cross-section of the used Cu wire was 0.65 mm×0.180 mm. Also, the number of turns of the Cu wire was set to 6.5 turns, and the inner diameter of the wound coil was set to 2.0 mm.

For Comparative example 2, a Cu wire of a rectangular wire shape having an insulation coating made of a polyimide resin was prepared, and the Cu wire was wound in a spiral form using an edgewise method. Thereby, an air core coil was produced. A dimension of a conductor part in a cross-section of the used Cu wire was 0.65 mm×0.180 mm. Also, the number of turns of the Cu wire was set to 6.5 turns, and the inner diameter of the wound coil was set to 2.0 mm.

In regards with Comparative example 1 and Comparative example 2, the inductance of the air core coil after being produced using the above-mentioned method was measured as L1 using a LCR meter. After L1 was measured, the air core coil was heat treated at 700° C. for 1 hour. In regards with Comparative example 1 and Comparative example 2, the inductance of the air core coil after the heat treatment was measured as L2 using a LCR meter. Note that, when L1 and L2 were measured, the measuring frequency was set to 1 MHz. For Comparative example 1 and Comparative example 2, an inductance change rate (%) after the heat treatment was also calculated based on a formula “((L2−L1)/L1×100” which is the same as in the case of the examples. Thereby, the heat resistance of the coil was measured.

Evaluation results of each example of Experiment 3 are shown in Table 3, and evaluation results of each comparative example are shown in Table 4.

TABLE 3

| | Number of | Coil before firing | | | Coil after firing | | | |
|---|---|---|---|---|---|---|---|---|
| | turns of | Pre-firing insulation layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example1 | 6.5 | Si | 30 | 0.0752 | Si | 18.0 | 0.0738 | −1.8 |
| Example2 | 6.5 | Al | 30 | 0.0749 | Al | 25.1 | 0.0696 | −7.1 |
| Example3 | 6.5 | Zr | 30 | 0.0752 | Zr | 28.9 | 0.0708 | −5.9 |
| Example4 | 6.5 | Zn | 30 | 0.0752 | Zn | 29.5 | 0.0709 | −5.7 |
| Example5 | 6.5 | Ti | 30 | 0.0749 | Ti | 28.7 | 0.0713 | −4.7 |
| Example6 | 6.5 | Nb | 30 | 0.0749 | Nb | 28.8 | 0.0708 | −5.4 |
| Example7 | 6.5 | Ta | 30 | 0.0748 | Ta | 29.7 | 0.0692 | −7.4 |
| Example8 | 6.5 | B | 30 | 0.0751 | B | 12.1 | 0.0703 | −6.3 |
| Example9 | 6.5 | Si, Ti | 30 | 0.0750 | Si, Ti | 25.1 | 0.0742 | −1.1 |
| Example10 | 6.5 | Si, B | 30 | 0.0747 | Si, B | 16.5 | 0.0726 | −2.8 |
| Example11 | 6.5 | Si, B, Al | 30 | 0.0745 | Si, B, Al | 21.2 | 0.0716 | −3.9 |
| Example12 | 6.5 | Ni | 30 | 0.0745 | Ni | 28.3 | 0.0589 | −21.0 |
| Example13 | 6.5 | Mg | 30 | 0.0745 | Mg | 28.5 | 0.0574 | −23.0 |

TABLE 4

| | Structure of coil | | | | | |
|---|---|---|---|---|---|---|
| | | | Number of | Measurement result of | | |
| | Insulation layer | | turns of | inductance | | |
| | | Average | conductive | | | Change |
| Sample | | thickness | wire | L1 | L2 | rate |
| No | Material | (μm) | (turns) | (μH) | (μH) | (%) |
| Comparative | Polyamideimide resin | 30 | 6.5 | 0.0750 | 0.0040 | −94.7 |
| example 1 | | | | | | |
| Comparative | Polyimide resin | 30 | 6.5 | 0.0760 | 0.0038 | −95.0 |
| example 2 | | | | | | |

As shown in Table 4, in both cases of Comparative example 1 and Comparative example 2, the insulation layer including the resin was lost after the heat treatment at 700° C., and short circuits occurred between the wires. Therefore, for Comparative example 1 and Comparative example 2, the inductance L2 of after the heat treatment was significantly lower than the inductance L1 of before the heat treatment.

On the other hand, as shown in Table 3, each air core coil of Examples 1 to 13 had the pre-firing insulation layer which included the organic compound containing the predetermined inorganic element M; thus, even after the firing treatment at 700° C., the insulation resistance between the wires was maintained, and a high heat resistance was achieved. In other words, by forming the inorganic insulation layer configured of the oxide containing the predetermined inorganic element M on the surface of the air core coil, a high heat resistance was achieved.

Particularly, in each of Examples 1 to 11, the inductance change rate was smaller than that of Examples 12 and 13. Based on the results, when the oxide of the inorganic insulation layer included at least one inorganic element M selected from the group consisting of Si, Al, Zr, Zn, Ti, Nb, Ta, and B, it was confirmed that the heat resistance of the coil was further improved.

### (Experiment 4)

In Experiment 4, the air core coils shown in Table 5 to Table 15 having different average thicknesses of the insulation coating layers were produced. Specifically, the average thickness of the insulation coating layer was adjusted to the values shown in Table 5 to Table 15 based on the repeating number of dip coating steps.

For Examples 1A to 1F of Table 5, a coating solution which was the same as the one used in Example 1 of Experiment 3 was used. For Examples 2A to 2F of Table 6, a coating solution which was the same as the one used in Example 2 of Experiment 3 was used. In Examples 3A to 3F of Table 7, a coating solution which was the same as the one used in Example 3 of Experiment 3 was used. For Examples 4A to 4F of Table 8, a coating solution which was the same as the one used in Example 4 of Experiment 3 was used. For Examples 5A to 5F of Table 9, a coating solution which was the same as the one used in Example 5 of Experiment 3 was used. For Examples 6A to 6F of Table 10, a coating solution which was the same as the one used in Example 6 of Experiment 3 was used. For Examples 7A to 7F of Table 11, a coating solution which was the same as the one used in Example 7 of Experiment 3 was used. For Examples 8A to 8F of Table 12, a coating solution which was the same as the one used in Example 8 of Experiment 3 was used. Examples 9A to 9F of Table 13, a coating solution which was the same as the one used in Example 9 of Experiment 3 was used. For Examples 10A to 10F of Table 14, a coating solution which was the same as the one used in Example 10 of Experiment 3 was used. For Examples 11A to 11F of Table 15, a coating solution which was the same as the one used in Example 11 of Experiment 3 was used.

For each example of Experiment 4, the same evaluations carried out in Experiment 3 were carried out. For Experiment 4, a sample having an inductance L1 of before firing of 0.0700 μH or greater and an inductance change rate of −7.5% or greater was considered “particularly good”. Evaluation results of Experiment 4 are shown in Table 5 to Table 15.

TABLE 5

| | Number of | Coil before firing | | | Coil after firing | | | |
|---|---|---|---|---|---|---|---|---|
| | turns of | Pre-firing insulation layer | | | Inorganic element M | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 1A | 6.5 | Si | 0.8 | 0.0752 | Si | 0.5 | 0.0691 | −8.1 |
| Example 1B | 6.5 | Si | 1.6 | 0.0751 | Si | 1.0 | 0.0714 | −4.9 |
| Example 1C | 6.5 | Si | 13 | 0.0752 | Si | 9.2 | 0.0739 | −1.8 |
| Example 1 | 6.5 | Si | 30 | 0.0752 | Si | 18.0 | 0.0738 | −1.8 |
| Example 1D | 6.5 | Si | 105 | 0.0724 | Si | 89.4 | 0.0708 | −2.2 |
| Example 1E | 6.5 | Si | 218 | 0.0705 | Si | 198 | 0.0699 | −0.9 |
| Example 1F | 6.5 | Si | 221 | 0.0668 | Si | 206 | 0.0663 | −0.8 |

TABLE 6

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 2A | 6.5 | Al | 0.7 | 0.0771 | Al | 0.6 | 0.0690 | −10.5 |
| Example 2B | 6.5 | Al | 1.7 | 0.0772 | Al | 1.1 | 0.0735 | −4.7 |
| Example 2C | 6.5 | Al | 17 | 0.0772 | Al | 15.2 | 0.0723 | −6.4 |
| Example 2 | 6.5 | Al | 30 | 0.0749 | Al | 25.1 | 0.0696 | −7.1 |
| Example 2D | 6.5 | Al | 106 | 0.0741 | Al | 102 | 0.0700 | −5.5 |
| Example 2E | 6.5 | Al | 217 | 0.0726 | Al | 197 | 0.0692 | −4.7 |
| Example 2F | 6.5 | Al | 223 | 0.0688 | Al | 210 | 0.0653 | −5.1 |

TABLE 7

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 3A | 6.5 | Zr | 0.7 | 0.0781 | Zr | 0.5 | 0.0720 | −7.8 |
| Example 3B | 6.5 | Zr | 1.6 | 0.0782 | Zr | 1.2 | 0.0738 | −5.6 |
| Example 3C | 6.5 | Zr | 14 | 0.0782 | Zr | 13.5 | 0.0741 | −5.3 |
| Example 3 | 6.5 | Zr | 30 | 0.0752 | Zr | 28.9 | 0.0708 | −5.9 |
| Example 3D | 6.5 | Zr | 103 | 0.0751 | Zr | 99.4 | 0.0703 | −6.4 |
| Example 3E | 6.5 | Zr | 218 | 0.0736 | Zr | 199 | 0.0685 | −6.9 |
| Example 3F | 6.5 | Zr | 221 | 0.0698 | Zr | 203 | 0.0652 | −6.7 |

TABLE 8

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 4A | 6.5 | Zn | 0.9 | 0.0766 | Zn | 0.8 | 0.0688 | −10.2 |
| Example 4B | 6.5 | Zn | 1.6 | 0.0767 | Zn | 1.2 | 0.0722 | −5.8 |
| Example 4C | 6.5 | Zn | 13 | 0.0767 | Zn | 12.5 | 0.0724 | −5.7 |
| Example 4 | 6.5 | Zn | 30 | 0.0752 | Zn | 29.5 | 0.0709 | −5.7 |
| Example 4D | 6.5 | Zn | 105 | 0.0736 | Zn | 104 | 0.0688 | −6.5 |
| Example 4E | 6.5 | Zn | 218 | 0.0721 | Zn | 198 | 0.0672 | −6.8 |
| Example 4F | 6.5 | Zn | 221 | 0.0683 | Zn | 205 | 0.0640 | −6.4 |

TABLE 9

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 5A | 6.5 | Ti | 0.8 | 0.0791 | Ti | 0.6 | 0.0706 | −10.7 |
| Example 5B | 6.5 | Ti | 1.6 | 0.0792 | Ti | 1.1 | 0.0746 | −5.7 |
| Example 5C | 6.5 | Ti | 14.5 | 0.0792 | Ti | 13.1 | 0.0748 | −5.6 |
| Example 5 | 6.5 | Ti | 30 | 0.0749 | Ti | 28.7 | 0.0713 | −4.7 |
| Example 5D | 6.5 | Ti | 105 | 0.0731 | Ti | 100 | 0.0684 | −6.4 |
| Example 5E | 6.5 | Ti | 219 | 0.0716 | Ti | 197 | 0.0668 | −6.7 |
| Example 5F | 6.5 | Ti | 222 | 0.0692 | Ti | 201 | 0.0649 | −6.3 |

TABLE 10

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 6A | 6.5 | Nb | 0.9 | 0.0764 | Nb | 0.7 | 0.0673 | −11.8 |
| Example 6B | 6.5 | Nb | 1.5 | 0.0765 | Nb | 1.1 | 0.0721 | −5.6 |
| Example 6C | 6.5 | Nb | 13.9 | 0.0765 | Nb | 12.8 | 0.0723 | −5.5 |
| Example 6 | 6.5 | Nb | 30 | 0.0749 | Nb | 28.8 | 0.0708 | −5.4 |
| Example 6D | 6.5 | Nb | 107 | 0.0734 | Nb | 104 | 0.0687 | −6.3 |
| Example 6E | 6.5 | Nb | 218 | 0.0719 | Nb | 197 | 0.0671 | −6.6 |
| Example 6F | 6.5 | Nb | 221 | 0.0681 | Nb | 203 | 0.0639 | −6.2 |

TABLE 11

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 7A | 6.5 | Ta | 0.7 | 0.0760 | Ta | 0.6 | 0.0683 | −10.1 |
| Example 7B | 6.5 | Ta | 1.7 | 0.0761 | Ta | 1.3 | 0.0716 | −5.8 |
| Example 7C | 6.5 | Ta | 16.1 | 0.0761 | Ta | 15.9 | 0.0718 | −5.6 |
| Example 7 | 6.5 | Ta | 30 | 0.0748 | Ta | 29.7 | 0.0692 | −7.4 |
| Example 7D | 6.5 | Ta | 102 | 0.0730 | Ta | 99.2 | 0.0682 | −6.5 |
| Example 7E | 6.5 | Ta | 218 | 0.0715 | Ta | 196 | 0.0665 | −7.0 |
| Example 7F | 6.5 | Ta | 226 | 0.0677 | Ta | 201 | 0.0628 | −7.2 |

TABLE 12

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 8A | 6.5 | B | 0.9 | 0.0763 | B | 0.6 | 0.0683 | −10.5 |
| Example 8B | 6.5 | B | 1.6 | 0.0764 | B | 1.0 | 0.0718 | −5.9 |
| Example 8C | 6.5 | B | 16 | 0.0764 | B | 8.5 | 0.0720 | −5.8 |
| Example 8 | 6.5 | B | 30 | 0.0751 | B | 12.1 | 0.0703 | −6.3 |
| Example 8D | 6.5 | B | 102 | 0.0733 | B | 87.5 | 0.0684 | −6.6 |
| Example 8E | 6.5 | B | 219 | 0.0718 | B | 189 | 0.0666 | −7.2 |
| Example 8F | 6.5 | B | 223 | 0.0680 | B | 201 | 0.0630 | −7.4 |

TABLE 13

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 9A | 6.5 | Si, Ti | 0.7 | 0.0768 | Si, Ti | 0.5 | 0.0706 | −8.1 |
| Example 9B | 6.5 | Si, Ti | 1.6 | 0.0769 | Si, Ti | 1.1 | 0.0731 | −4.9 |
| Example 9C | 6.5 | Si, Ti | 14 | 0.0769 | Si, Ti | 12.6 | 0.0755 | −1.8 |
| Example 9 | 6.5 | Si, Ti | 30 | 0.0750 | Si, Ti | 25.1 | 0.0742 | −1.1 |
| Example 9D | 6.5 | Si, Ti | 106 | 0.0738 | Si, Ti | 93.2 | 0.0722 | −2.2 |
| Example 9E | 6.5 | Si, Ti | 217 | 0.0723 | Si, Ti | 198 | 0.0716 | −0.9 |
| Example 9F | 6.5 | Si, Ti | 223 | 0.0685 | Si, Ti | 203 | 0.0680 | −0.8 |

TABLE 14

| | | Coil before firing | | | Coil after firing | | | |
|---|---|---|---|---|---|---|---|---|
| | Number of | Pre-firing insulation | | | | | | |
| | turns of | layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 10A | 6.5 | Si, B | 0.8 | 0.0767 | Si, B | 0.7 | 0.0703 | −8.3 |
| Example 10B | 6.5 | Si, B | 1.7 | 0.0768 | Si, B | 1.1 | 0.0730 | −4.9 |
| Example 10C | 6.5 | Si, B | 12.2 | 0.0768 | Si, B | 10.3 | 0.0753 | −2.0 |
| Example 10 | 6.5 | Si, B | 30 | 0.0747 | Si, B | 16.5 | 0.0726 | −2.8 |
| Example 10D | 6.5 | Si, B | 105 | 0.0737 | Si, B | 87.5 | 0.0716 | −2.8 |
| Example 10E | 6.5 | Si, B | 219 | 0.0722 | Si, B | 190 | 0.0717 | −0.7 |
| Example 10F | 6.5 | Si, B | 224 | 0.0684 | Si, B | 202 | 0.0683 | −0.2 |

TABLE 15

| | Number of | Coil before firing | | | Coil after firing | | | |
|---|---|---|---|---|---|---|---|---|
| | turns of | Pre-firing insulation layer | | | Inorganic insulation layer | | | |
| | conductive | | Average | | | Average | | Inductance |
| Sample | wire | Inorganic | thickness | L1 | Inorganic | thickness | L2 | change rate |
| No | (turns) | element M | (μm) | (μH) | element M | (μm) | (μH) | (%) |
| Example 11A | 6.5 | Si, B, Al | 0.8 | 0.0763 | Si, B, Al | 0.6 | 0.0696 | −8.7 |
| Example 11B | 6.5 | Si, B, Al | 1.5 | 0.0764 | Si, B, Al | 1.1 | 0.0727 | −4.8 |
| Example 11C | 6.5 | Si, B, Al | 13.1 | 0.0764 | Si, B, Al | 10.1 | 0.0728 | −4.8 |
| Example 11 | 6.5 | Si, B, Al | 30 | 0.0745 | Si, B, Al | 21.2 | 0.0716 | −3.9 |
| Example 11D | 6.5 | Si, B, Al | 107 | 0.0733 | Si, B, Al | 99.2 | 0.0712 | −2.9 |
| Example 11E | 6.5 | Si, B, Al | 218 | 0.0718 | Si, B, Al | 199 | 0.0716 | −0.3 |
| Example 11F | 6.5 | Si, B, Al | 223 | 0.0680 | Si, B, Al | 204 | 0.0675 | −0.8 |

As shown in Table 5 to Table 15, when a sample had the average thickness of the pre-firing insulation layer of 1.5 μm or thicker and 220 μm or thinner, the inductance L1 of before firing was 0.0700 μH or greater and the inductance change rate of after firing was −7.5%. Based on the results of Experiment 4, it was confirmed that the average thickness of the pre-firing insulation layer was preferably 1.5 μm or thicker and 220 μm or thinner and the average thickness of the inorganic insulation layer was preferably 1 μm or thicker and 200 μm or thinner

### (Experiment 5)

In Experiment 5, using the coils produced in Experiment 3, magnetic components (inductors) of 13 different types (Example M1 to Example M11 of Table 16 and Comparative examples M1 and M2 of Table 17) shown in Table 16 and Table 17 were produced. In each example and each comparative example of Experiment 5, a numerical part of the sample number corresponds to the sample number of Experiment 3. That is, for Comparative example M1, the coil having the insulation coating of polyamideimide resin was used, which is the same as in the case of Comparative example 1 of Experiment 3; and for Comparative example M2, the coil having the insulation coating of a polyimide resin was used, which is the same as in the case of Comparative example 2 of Experiment 3. Also, for each of Examples M1 to M11, the coil having the insulation coating containing the inorganic element M shown in Table 16 was used, which is the same as in the case of Examples 1 to 11 of Experiment 3. A diameter (an average diameter of Cu wire) of the coil and an inner diameter of the coil used for each Example and Comparative example were the same as in the case of Experiment 3.

For each Example and each Comparative example of Experiment 5, a Fe—Si alloy powder was used as a magnetic powder. An average particle size of the Fe—Si alloy powder used in Experiment 5 was 30 μm, and on the surface of each particle, an insulation coating having an average thickness of 50 nm and made of a composite oxide of Si and Ti was formed. In Experiment 5, the above-mentioned Fe—Si alloy powder was mixed with a silicone resin as a binder, and thereby a composite material was obtained.

In each Example, a coil having a pre-firing insulation layer was placed inside a cavity of a mold, and the cavity was filled with the above-mentioned composite material, then pressure was applied. Due to this molding step, a magnetic component which the coil having the pre-firing insulation layer was embedded inside a dust core was obtained. In Experiment 5, an inductance L3 (μH) of the magnetic component was measured using a LCR meter. Here, the measuring frequency was set to 1 MHz.

Also, in Experiment 5, after the inductance L3 was measured, the magnetic component was heat treated at 700° C. for 1 hour to sinter the dust core. In each Example, it was confirmed that, due to this heat treatment, the insulation coating of the coil turned into the inorganic insulation layer which did not include the organic compound. It was also confirmed that the oxide of the inorganic insulation layer included the inorganic element M shown in Table 16.

After the dust core was sintered using the above-mentioned method, an inductance L4 (μH) of the magnetic component of after sintering was measured using a LCR meter. Here, the measuring frequency was set to 1 MHz. In Experiment 3, a sample that the inductance L4 of after sintering became larger than the inductance L3 of after molding (that is, a sample satisfying L3<L4) was considered “good”. Results of Experiment 5 are shown in Table 16 and table 17.

TABLE 16

| | | | Magnetic core before firing | | | Magnetic core after firing | | |
|---|---|---|---|---|---|---|---|---|
| | | Number of | Pre-firing insulation | | | Inorganic insulation | | |
| | | turns of | layer of coil | | | layer of coil | | |
| | Material of | conductive | | Average | | | Average | |
| Sample | magnetic | wire | Inorganic | thickness | L3 | Inorganic | thickness | L4 |
| No | powder | (turns) | element M | (μm) | (μH) | element M | (μm) | (μH) |
| Example M1 | Fe—Si alloy | 6.5 | Si | 30 | 0.737 | Si | 18.0 | 0.982 |
| Example M2 | Fe—Si alloy | 6.5 | Al | 30 | 0.697 | Al | 25.1 | 0.929 |
| Example M3 | Fe—Si alloy | 6.5 | Zr | 30 | 0.706 | Zr | 28.9 | 0.941 |
| Example M4 | Fe—Si alloy | 6.5 | Zn | 30 | 0.707 | Zn | 29.5 | 0.943 |
| Example M5 | Fe—Si alloy | 6.5 | Ti | 30 | 0.715 | Ti | 28.7 | 0.953 |
| Example M6 | Fe—Si alloy | 6.5 | Nb | 30 | 0.710 | Nb | 28.8 | 0.946 |
| Example M7 | Fe—Si alloy | 6.5 | Ta | 30 | 0.695 | Ta | 29.7 | 0.926 |
| Example M8 | Fe—Si alloy | 6.5 | B | 30 | 0.703 | B | 12.1 | 0.937 |
| Example M9 | Fe—Si alloy | 6.5 | Si, Ti | 30 | 0.742 | Si, Ti | 25.1 | 0.989 |
| Example M10 | Fe—Si alloy | 6.5 | Si, B | 30 | 0.729 | Si, B | 16.5 | 0.972 |
| Example M11 | Fe—Si alloy | 6.5 | Si, B, Al | 30 | 0.721 | Si, B, Al | 21.2 | 0.961 |

TABLE 17

| | | Coil | | | | |
|---|---|---|---|---|---|---|
| | | | | Number of | | |
| | | Insulation coating | | turns of | Measurement results of | |
| | Magnetic core | | Average | conductive | inductance | |
| Sample | Material of | | thickness | wire | L3 | L4 |
| No | magnetic powder | Material | (μm) | (turns) | (μH) | (μH) |
| Comparative | Fe—Si alloy | Polyamideimide resin | 30 | 6.5 | 0.750 | 0.042 |
| example M1 | | | | | | |
| Comparative | Fe—Si alloy | Polyimide resin | 30 | 6.5 | 0.750 | 0.080 |
| example M2 | | | | | | |

As shown in Table 17, in Comparative example M1 and M2, a filling rate of the magnetic powder improved by carrying out sintering, however, the insulation coating on the surface of the coil (the insulation coating including the resin) was lost during the heat treatment, and short circuits occurred between the wires of the coil. As a result, the number of turns of the coil substantially decreased after sintering the magnetic core, and the inductance LA of after sintering was significantly decreased compared to the inductance L3 of after molding.

On the other hand, as shown in Table 16, in each of Example M1 to Example M11 which used the coil having the insulation coating (the pre-firing insulation coating and the inorganic insulation coating) including the predetermined inorganic element M, the insulation resistance between the coils was maintained by the inorganic insulation layer even after the magnetic core was sintered. Further, for Example M1 to Example M11, because the filling rate of the magnetic powder improved due to sintering of the magnetic core, it was possible to achieve a higher inductance L4 than the inductance L3 of after molding.

### [Supplementary Note]

The technology according to the present disclosure includes the below described configuration examples, however, the present disclosure is not limited to these.

### [Supplementary Note 1]

An insulation coated conductive wire including:
a metal conductor part including Cu, and an insulation layer coating the metal conductor part;
wherein the insulation layer includes Si, Ti, and oxygen;
   a ratio of a Ti content with respect to a total content of Si and Ti in the insulation layer is 2.5 at % or more and 50 at % or less.

### [Supplementary Note 2]

The insulation coated conductive wire according to Supplementary Note 1, wherein an average thickness of the insulation layer is 1 μm or thicker and 220 μm thinner.

### [Supplementary Note 3]

An insulation coated conductive wire including:
a metal conductor part including Cu, and an inorganic insulation layer coating the metal conductor part;
wherein the inorganic insulation layer comprises an oxide including Si and Ti, and
a ratio of a Ti content with respect to a total content of Si and Ti in the inorganic insulation layer is 2.5 at % or more and 50 at % or less.

### [Supplementary Note 4]

The insulation coated conductive wire according to Supplementary Note 3, wherein an average thickness of the inorganic insulation layer is 1 μm or thicker and 200 μm thinner.

### [Supplementary Note 5]

A coil including:
a conductive wire including a metal conductor part including Cu, and an insulation layer coating the metal conductor part;
wherein the insulation layer includes an organic compound comprising an inorganic element M which is one or more element selected from the group consisting of Si, Al, Zr, Zn, Ti, Nb, Ta, B, Ni, and Mg.

### [Supplementary Note 6]

The coil according to Supplementary Note 5, wherein the organic compound includes one or more element selected from the group consisting of Si, Al, Zr, Zn, Ti, Nb, Ta, and B as the inorganic element M.

### [Supplementary Note 7]

The coil according to Supplementary Note 5 or 6, wherein an average thickness of the insulation layer is 1.5 μm or thicker and 220 μm thinner.

### [Supplementary Note 8]

A coil including:
a conductive wire including a metal conductor part including Cu, and an inorganic insulation layer coating the metal conductor part;
wherein the inorganic insulation layer includes an oxide comprising an inorganic element M which is one or more element selected from the group consisting of Si, Al, Zr, Zn, Ti, Nb, Ta, B, Ni, and Mg.

### [Supplementary Note 9]

The coil according to Supplementary Note 8, wherein the oxide includes one or more element selected from the group consisting of Si, Al, Zr, Zn, Ti, Nb, Ta, and B as the inorganic element M.

### [Supplementary Note 10]

The coil according to Supplementary Note 8 or 9, wherein an average thickness of the inorganic insulation layer is 1 μm or thicker and 200 μm thinner.

### [Supplementary Note 11]

A magnetic component including:
the coil according to any one of Supplementary Notes 5 to 10, and a magnetic core including a soft magnetic material;
wherein the coil is embedded inside the magnetic core.

### REFERENCE SIGNS LISTS

2, 2α, 2β . . . Insulation coated conductive wire (conductive wire)
   2s . . . Outermost surface
   2e1, 2e2 . . . End part
      6 . . . Metal conductor part
         6a . . . Main part
         6b . . . Metal coating layer
      8 . . . Insulation layer (insulation coating)
         8A . . . Pre-firing insulation layer
         8B . . . Inorganic insulation layer
      20, 20α . . . . Coil
      100 . . . Electronic component (Magnetic component)
      40 . . . Magnetic core

1. An insulation coated conductive wire comprising:
a metal conductor part including Cu, and an insulation layer coating the metal conductor part;
wherein the insulation layer comprises Si, Ti, and oxygen;
a ratio of a Ti content with respect to a total content of Si and Ti in the insulation layer is 2.5 at % or more and 50 at % or less.

2. The insulation coated conductive wire according to claim 1, wherein an average thickness of the insulation layer is 1 μm or thicker and 220 μm thinner.

3. An insulation coated conductive wire comprising:
a metal conductor part including Cu, and an inorganic insulation layer coating the metal conductor part;
wherein the inorganic insulation layer comprises an oxide including Si and Ti, and
a ratio of a Ti content with respect to a total content of Si and Ti in the inorganic insulation layer is 2.5 at % or more and 50 at % or less.

4. The insulation coated conductive wire according to claim 3, wherein an average thickness of the inorganic insulation layer is 1 μm or thicker and 200 μm thinner.

5. A coil comprising:
a conductive wire including a metal conductor part including Cu, and an insulation layer coating the metal conductor part;
wherein the insulation layer comprises an organic compound comprising an inorganic element M which is one or more element selected from the group consisting of Si, Al, Zr, Zn, Ti, Nb, Ta, B, Ni, and Mg.

6. The coil according to claim 5, wherein the organic compound includes one or more element selected from the group consisting of Si, Al, Zr, Zn, Ti, Nb, Ta, and B as the inorganic element M.

7. The coil according to claim 5, wherein an average thickness of the insulation layer is 1.5 μm or thicker and 220 μm thinner.

8. A coil comprising:
a conductive wire including a metal conductor part including Cu, and an inorganic insulation layer coating the metal conductor part;
wherein the inorganic insulation layer includes an oxide comprising an inorganic element M which is one or more element selected from the group consisting of Si, Al, Zr, Zn, Ti, Nb, Ta, B, Ni, and Mg.

9. The coil according to claim 8, wherein the oxide includes one or more element selected from the group consisting of Si, Al, Zr, Zn, Ti, Nb, Ta, and B as the inorganic element M.

10. The coil according to claim 8, wherein an average thickness of the inorganic insulation layer is 1 μm or thicker and 200 μm thinner.

11. A magnetic component comprising:
the coil according to claim 8, and a magnetic core including a soft magnetic material;
wherein the coil is embedded inside the magnetic core.
